(19) United States
(12) Patent Application Publication
(10) Pub. No.: US 2024/0262694 A1
(43) Pub. Date: Aug. 8, 2024

(54) SOLID CARBON COMPOSITION

(71) Applicant: Impossible Diamond, Inc., New York, NY (US)

(72) Inventors: Ryan Shearman, New York, NY (US); Daniel Wojno, New York, NY (US); Anthony W. Ippolito, JR., New York, NY (US)

(21) Appl. No.: 18/600,524

(22) Filed: Mar. 8, 2024

Related U.S. Application Data
(63) Continuation-in-part of application No. 18/345,918, filed on Jun. 30, 2023.
Application No. 18/345,918 is a continuation of application No. 17/814,495, filed on Jul. 22, 2022, now Pat. No. 11,713,250.
Application No. 17/814,495 is a continuation-in-part of application No. 17/314,018, filed on May 6, 2021, now Pat. No. 11,371,162.
(60) Provisional application No. 63/450,913, filed on Mar. 8, 2023.
(60) Provisional application No. 63/225,365, filed on Jul. 23, 2021.
(60) Provisional application No. 63/020,980, filed on May 6, 2020.

(51) Int. Cl. C01B 32/26; A44C 17/00; C10G 2/00

(52) U.S. Cl. CPC C01B 32/26; C10G 2/50; A44C 17/00; C01P 2006/32; C01P 2006/88

(57) ABSTRACT

One variation of a solid carbon composition forms a solid carbon product derived from a hydrocarbon mixture: including methane including carbon sourced from captured gas; and formed via methanation of a carbon dioxide mixture extracted from captured gas via a point source capture process. The solid carbon composition includes carbon sourced from captured gas and including: a first amount of carbon-13 isotopes; and a second amount of carbon-12 isotopes. The solid carbon composition exhibits an isotopic signature defining a ratio of the first amount of carbon-13 isotopes to the second amount of carbon-12 isotopes exceeding −50.0 parts-per-thousand-versus-PDB-standard.

### CROSS-REFERENCE TO RELATED APPLICATIONS

This application claims the benefit of U.S. Provisional Application No. 63/450,913, filed on 8 Mar. 2023, which is incorporated in its entirety by this reference.

This Application is also a continuation-in-part of U.S. patent application Ser. No. 18/345,918, filed on 30 Jun. 2023, which is a continuation application of U.S. patent application Ser. No. 17/814,495, filed on 22 Jul. 2022, which claims the benefit of U.S. Provisional Application No. 63/225,365, filed on 23 Jul. 2021, and is a continuation-in-part of U.S. patent application Ser. No. 17/314,018, filed on 6 May 2021, which claims the benefit of U.S. Provisional Application No. 63/020,980, filed on 6 May 2020, each of which is incorporated in its entirety by this reference.

### TECHNICAL FIELD

This invention relates generally to the field of carbon product synthesis and more specifically to a new and useful composition for a solid carbon product in the field of carbon product synthesis.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIG. 4 is a flowchart representation of one variation of the method;

FIG. 5 is a schematic representation of a carbon composition;

FIG. 6 is a flowchart representation of one variation of the method;

FIG. 7 is a schematic representation of a diamond composition;

FIG. 8 is a schematic representation of one variation of the diamond composition;

FIG. 9 is a flowchart representation of one variation of the method;

FIG. 10 is a flowchart representation of one variation of the method; and

FIG. 11 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Composition: Solid Carbon Product

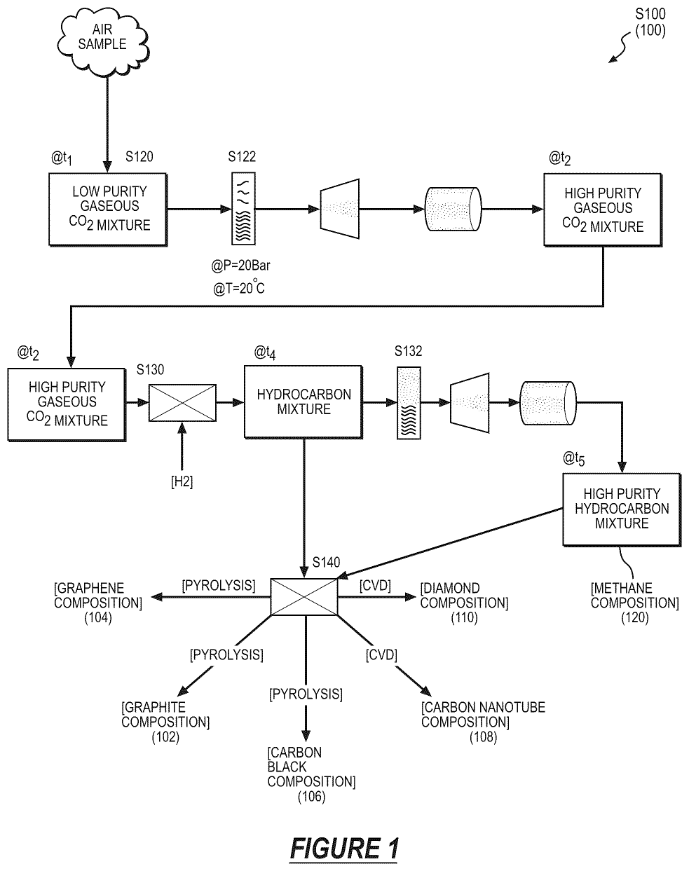

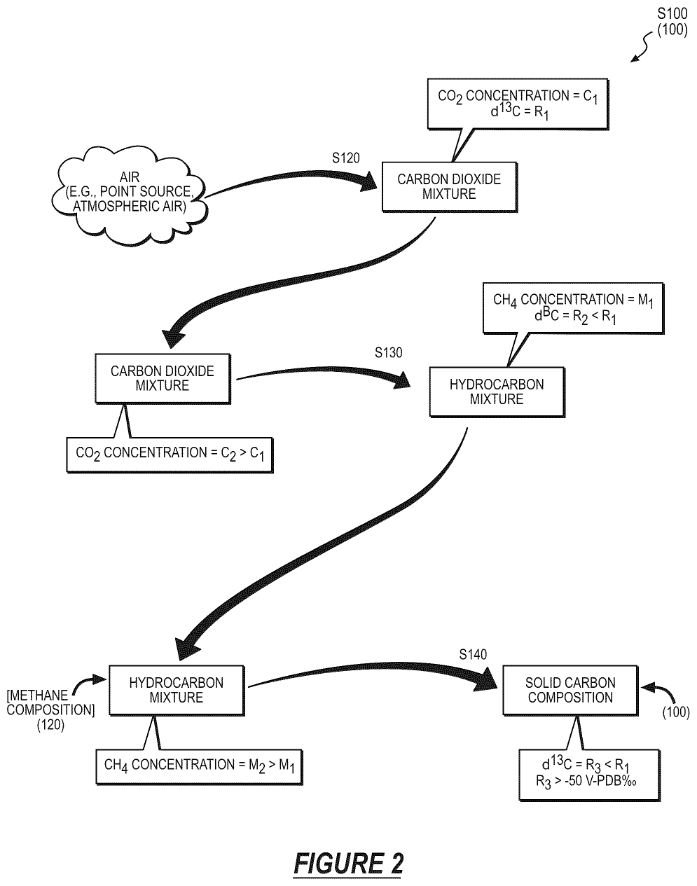

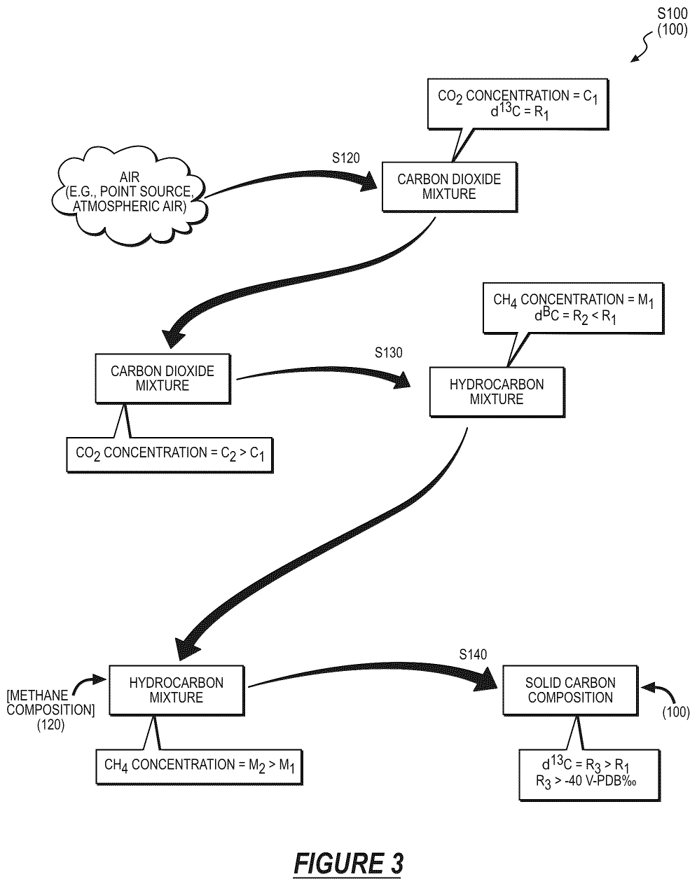

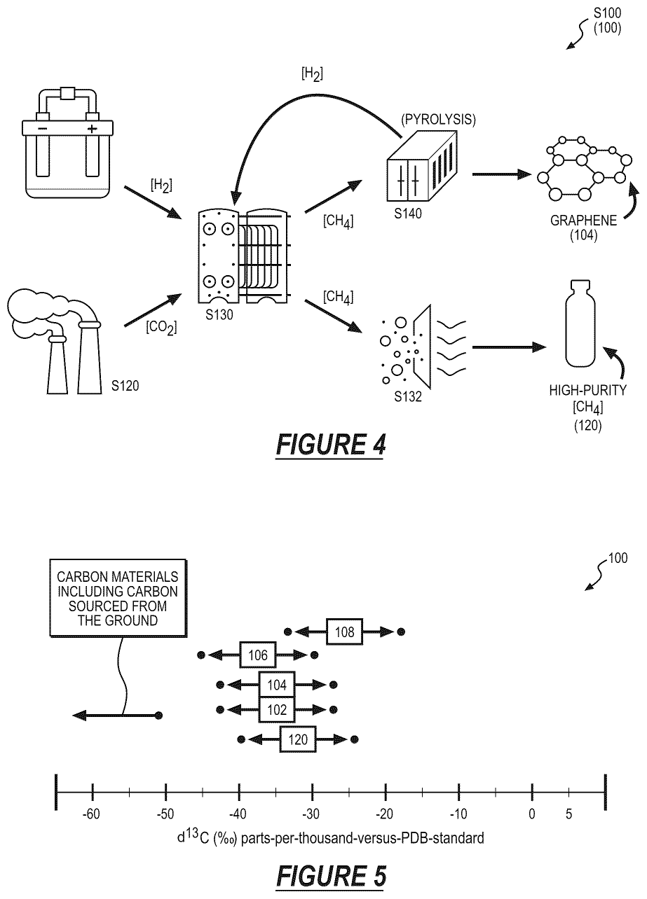

As shown in FIGS. 1-6, a carbon composition 100 includes carbon sourced from captured gas (e.g., a point source, atmospheric air) and including: a first amount (e.g., concentration) of carbon-13 isotopes; and a second amount of carbon-12 isotopes. The carbon composition 100 defines a ratio of the first amount of carbon-13 isotopes to the second amount of carbon-12 isotopes greater than −50.0 parts per thousand relative a Pee Dee Belemnite standard (hereinafter “parts-per-thousand-versus-PDB-standard”).

One variation of the carbon composition 100 includes carbon sourced from captured gas and including: a first amount of carbon-13 isotopes; and a second amount of carbon-12 isotopes. In this variation, the carbon composition 100 defines a ratio of the first amount of carbon-13 isotopes to the second amount of carbon-12 isotopes greater than −50.0 parts-per-thousand-versus-PDB-standard and less than zero parts-per-thousand-versus-PDB-standard.

One variation of the carbon composition 100 includes carbon sourced from captured gas and including: a first amount of carbon-13 isotopes; and a second amount of carbon-12 isotopes. In this variation, the carbon composition 100 defines a ratio of the first amount of carbon-13 isotopes to the second amount of carbon-12 isotopes greater than −40.0 parts-per-thousand-versus-PDB-standard and less than −10.0 parts-per-thousand-versus-PDB-standard.

### 1.1 Composition: Graphene

In one implementation, the carbon composition 100 forms graphene (i.e., a graphene composition 104) including carbon sourced from captured gas and including: a first amount of carbon-13 isotopes; and a second amount of carbon-12 isotopes. The carbon composition 100 exhibits an isotopic signature defining a ratio of the first amount of carbon-13 isotopes to the second amount of carbon-12 isotopes exceeding −50.0 parts-per-thousand-versus-PDB-standard.

### 1.2 Composition: Graphite

In one implementation, the carbon composition 100 forms graphite (i.e., a graphite composition 102) including carbon sourced from captured gas and including: a first amount of carbon-13 isotopes; and a second amount of carbon-12 isotopes. The carbon composition 100 exhibits an isotopic signature defining a ratio of the first amount of carbon-13 isotopes to the second amount of carbon-12 isotopes exceeding −50.0 parts-per-thousand-versus-PDB-standard.

### 1.3 Composition: Carbon Black

In one implementation, the carbon composition 100 forms carbon black (i.e., a carbon black composition 106) including carbon sourced from captured gas and including: a first amount of carbon-13 isotopes; and a second amount of carbon-12 isotopes. The carbon composition 100 exhibits an isotopic signature defining a ratio of the first amount of carbon-13 isotopes to the second amount of carbon-12 isotopes exceeding −50.0 parts-per-thousand-versus-PDB-standard.

### 1.4 Composition: Carbon Nanotubes

In one implementation, the carbon composition 100 forms carbon nanotubes (i.e., a carbon nanotube composition 108) including carbon sourced from captured gas and including: a first amount of carbon-13 isotopes; and a second amount of carbon-12 isotopes. The carbon composition 100 exhibits an isotopic signature defining a ratio of the first amount of carbon-13 isotopes to the second amount of carbon-12 isotopes exceeding −40.0 parts-per-thousand-versus-PDB-standard.

### 1.5 Composition: Diamond

A diamond composition 110 includes: a first amount (e.g., concentration) of carbon-13 isotopes; and a second amount of carbon-12 isotopes. The diamond composition 110 is formed via chemical vapor deposition and defines a ratio of the first amount of carbon-13 isotopes to the second amount of carbon-12 isotopes greater than −10.0 parts per thousand relative a Pee Dee Belemnite standard (hereinafter “parts-per-thousand-versus-PDB-standard”).

One variation of the diamond composition 110 includes: a first amount of carbon-13 isotopes; and a second amount of carbon-12 isotopes. The diamond composition 110 includes carbon sourced from air and defines a ratio of the first amount of carbon-13 isotopes to the second amount of carbon-12 isotopes greater than −10.0 parts-per-thousand-versus-PDB-standard.

One variation of the diamond composition 110 includes: a first amount of carbon-13 isotopes; and a second amount of carbon-12 isotopes. The diamond composition 110 is formed via chemical vapor deposition and defines a ratio of the first amount of carbon-13 isotopes to the second amount of carbon-12 isotopes greater than −5.0 parts-per-thousand-versus-PDB-standard.

One variation of the diamond composition 110 includes: a first amount of carbon-13 isotopes; and a second amount of carbon-12 isotopes. The diamond composition 110 defines a ratio of the first amount of carbon-13 isotopes to the second amount of carbon-12 isotopes between −4.0 parts-per-thousand-versus-PDB-standard and −3.0 parts-per-thousand-versus-PDB-standard.

One variation of the diamond composition 110 includes: a first amount of carbon-13 isotopes; and a second amount of carbon-12 isotopes. The diamond composition 110 defines a ratio of the first amount of carbon-13 isotopes to the second amount of carbon-12 isotopes between −3.610 parts-per-thousand-versus-PDB-standard and −3.590 parts-per-thousand-versus-PDB-standard.

One variation of the diamond composition 110 includes carbon: sourced from air; including a first amount of carbon-13 isotopes; and including a second amount of carbon-12 isotopes. In this variation, the diamond composition 110 is formed via chemical vapor deposition of a diamond seed and exhibits an isotopic signature defining a first ratio of the first amount of carbon-13 isotopes to the second amount of carbon-12 isotopes within a first target range between −10.0 parts-per-thousand-versus-PDB-standard and 1.0 parts-per-thousand-versus-PDB-standard.

One variation of the diamond composition 110 includes carbon sourced from air and including a first amount of carbon-13 isotopes, a second amount of carbon-12 isotopes, and a third amount of carbon-14 isotopes. The diamond composition 110 is formed via chemical vapor deposition of a diamond seed and exhibits an isotopic signature defining a ratio of the first amount of carbon-13 isotopes to the second amount of carbon-12 isotopes within a target range between −4.0 parts-per-thousand-versus-PDB-standard and −3.0 parts-per-thousand-versus-PDB-standard.

One variation of the diamond composition 110: includes carbon sourced from air and including a first amount of carbon-13 isotopes and a second amount of carbon-12 isotope; is formed via chemical vapor deposition of a diamond seed exposed to a gaseous hydrocarbon mixture, the gaseous hydrocarbon mixture including hydrocarbons sourced from air and formed via methanation of a carbon dioxide mixture extracted from an air sample and including carbon dioxide and impurities (e.g., nitrogen); and exhibits an isotopic signature defining a first ratio of the first amount of carbon-13 isotopes to the second amount of carbon-12 isotopes exceeding a threshold ratio of −10.0 parts-per-thousand-versus-PDB-standard.

One variation of the diamond composition 110 includes carbon including a first amount of carbon-13 isotopes and a second amount of carbon-12 isotopes; and sourced from a hydrocarbon mixture including hydrocarbons and formed via methanation of a carbon dioxide mixture: sourced from a sample of air including carbon dioxide and a first concentration of impurities; conveyed through a separation unit configured to remove impurities from the carbon dioxide mixture; including carbon dioxide and a second concentration of impurities less than the first concentration of impurities at an outlet of the separation unit; conveyed through a distillation column configured to regulate amounts of carbon-13 isotopes and carbon-12 isotopes in the carbon dioxide mixture; and exhibiting a target ratio of carbon-13 isotopes to carbon-12 isotopes at an outlet of the distillation column. The diamond composition 110 is also formed via chemical vapor deposition of a diamond seed exposed to the hydrocarbon mixture and exhibits an isotopic signature defining a final ratio of the first amount of carbon-13 isotopes to the second amount of carbon-12 isotopes within a first target range corresponding to the target ratio exhibited by the carbon dioxide mixture.

### 2. Method: Generation of the Carbon Composition

As shown in FIGS. 1-4 and 6, a method S100 for generating a carbon composition 100 includes: extracting a carbon dioxide mixture from a volume of gas (e.g., flue gas, air), the carbon dioxide mixture including carbon dioxide and defining a first ratio of carbon-13 isotopes to carbon-12 isotopes exceeding −40 parts-per-thousand-versus-PDB-standard and less than zero parts-per-thousand-versus-PDB-standard; reacting the carbon dioxide mixture with a stream of hydrogen, in the presence of a catalyst, to generate a hydrocarbon mixture including methane and defining a second ratio of carbon-13 isotopes to carbon-12 isotopes less than the first ratio; and, in a reactor, converting the hydrocarbon mixture to a target carbon composition 100 via a target conversion process corresponding to the target carbon composition 100, the target carbon composition 100 including carbon and defining a third ratio of carbon-13 isotopes to carbon-12 isotopes less than the second ratio, the third ratio exceeding −50 parts-per-thousand-versus-PDB-standard.

One variation of the method S100 includes: extracting a carbon dioxide mixture from a volume of gas, the carbon dioxide mixture including carbon dioxide and defining a first ratio of carbon-13 isotopes to carbon-12 isotopes exceeding −40 parts-per-thousand-versus-PDB-standard and less than zero parts-per-thousand-versus-PDB-standard; reacting the carbon dioxide mixture with a stream of hydrogen, in the presence of a catalyst, to generate a hydrocarbon mixture including methane and defining a second ratio of carbon-13 isotopes to carbon-12 isotopes less than the first ratio; and, in a reactor, converting the hydrocarbon mixture to a carbon nanotube composition 108 via a target conversion process corresponding to the carbon nanotube composition 108, the carbon nanotube composition 108 including carbon and defining a third ratio of carbon-13 isotopes to carbon-12 isotopes exceeding the first ratio, the third ratio exceeding −35 parts-per-thousand-versus-PDB-standard.

### 2.1 Method: Diamond Generation

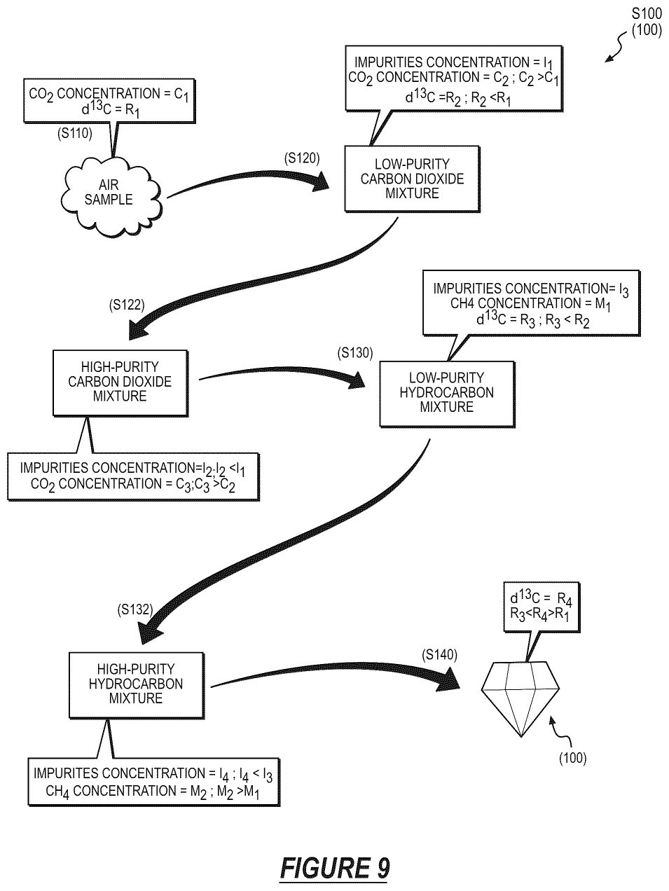

As shown in FIGS. 1, 3, and 6-9, a method S100 for generating a synthetic (e.g., lab-grown) diamond includes: collecting an air sample including carbon dioxide and defining a first ratio of carbon-13 isotopes to carbon-12 isotopes in Block S110; extracting a carbon dioxide mixture from the air sample, the carbon dioxide mixture including carbon dioxide and defining a second ratio of carbon-13 isotopes to carbon-12 isotopes less than the first ratio in Block S120; reacting the carbon dioxide mixture with a stream of hydrogen, in the presence of a catalyst, to generate a hydrocarbon mixture including methane and defining a third ratio of carbon-13 isotopes to carbon-12 isotopes less than the second ratio in Block S130; exposing the hydrocarbon mixture to a diamond seed to generate a diamond composition 110 defining a fourth ratio of carbon-13 isotopes to carbon-12 isotopes greater than the first ratio in Block S140.

### 3. Applications

Generally, the diamond composition 110 is an ethically-sourced, lab-grown, carbon-negative, jewelry-grade diamond. In particular, the method S100 can be executed to: directly capture a gaseous mixture of carbon dioxide and other components found in air (e.g., nitrogen, argon) from an air source (e.g., re-circulated air within a building, outdoor air, air pollution, human breath, a flue stack); to process this gaseous mixture of carbon dioxide and other components—according to various chemical techniques and/or in combination with additional components—to form a hydrocarbon mixture; and to further react this hydrocarbon mixture to form the diamond composition 110 (e.g., a jewelry-grade diamond). By implementing direct capture of a gaseous carbon dioxide mixture from air and transforming this mixture into a hydrocarbon precursor (i.e., the hydrocarbon mixture) for production of the diamond composition 110, the method S100 enables elimination of pollution, greenhouse gases, and mineral and water waste generated due to sourcing hydrocarbons (e.g., fossil fuels) directly from the ground via mining.

Further, the diamond composition 110 includes carbon isotopic concentrations similar to natural diamonds (e.g., ground-sourced diamonds). In particular, the diamond composition 110 defines a particular carbon isotopic signature (e.g., a ratio of carbon-13 isotopes to carbon-12 isotopes present in the diamond composition 110) within a similar range exhibited by natural diamonds (e.g., ground-sourced diamonds). Therefore, by sourcing carbon from the air—rather than the ground the diamond composition 110 is less depleted in carbon-13 isotopes than traditional lab-grown diamonds (e.g., ground-sourced HPHT and/or CVD diamonds) which may be more heavily depleted in carbon-13.

This carbon isotopic signature can be leveraged to distinguish natural diamonds (e.g., ground-sourced diamonds) from traditional lab-grown diamonds by measuring carbon isotopic concentrations of these diamonds via mass spectroscopy in a standard carbon-13 test. For example, natural diamonds (e.g., ground-sourced diamonds) can exhibit carbon isotopic signatures within a target range (e.g., including greater than 95 percent of Peridotitic diamonds). Traditional lab-grown diamonds (e.g., ground-sourced HPHT and/or CVD diamonds) are more depleted in carbon-13 isotopes than natural diamonds (e.g., ground-sourced diamonds), and exhibit carbon isotopic signatures outside of this target range. These traditional lab-grown diamonds are therefore readily detectable as synthetic diamonds when subjected to the standard carbon-13 test. However, by sourcing carbon from atmospheric air—which is more enriched in carbon-13 isotopes—the diamond composition 110 can exhibit a carbon isotopic signature within this target range.

The diamond composition 110 is therefore indistinguishable from natural diamonds (e.g., ground-sourced diamonds), when subjected to the standard carbon-13 test, while detectably (e.g., via mass spectrometry) distinct from other lab-grown diamonds.

Further, the carbon isotopic signature of the diamond composition 110 can be predictably linked to a particular time period and location corresponding to collection of the original air sample from which carbon was extracted and transformed into this diamond composition 110. For example, a model linking carbon isotopic concentrations in ambient air to time period and location of air capture can be theoretically derived based on observed weather patterns (e.g., seasonal and geographic weather patterns).

This model can therefore predictably identify a time period (e.g., a season, a particular month) and/or location (e.g., a latitude) of air capture for a particular diamond, formed of the diamond composition 110 and generated via the method S100, based on the carbon isotopic signature of this particular diamond. For example, a user may purchase a diamond, formed of the diamond composition 110100, and generated from an air sample collected at a particular location (e.g., a geographic location). To determine a time period during which the air sample was collected, the user may access a carbon isotopic signature of her diamond, such as by bringing the diamond to a lab for testing. The user may then leverage an existing model linking carbon isotopic signature, air capture location, and air capture time period of diamonds formed of the diamond composition 110, to estimate the time period during which the air sample for her diamond was captured.

### 4. Air to Diamond

Generally—as described in U.S. patent application Ser. No. 18/345,918, filed on 30 Jun. 2023, which is incorporated in its entirety by this reference—the diamond composition 110 can be generated by: directly capturing a gaseous mixture of carbon dioxide and other components found in air (e.g., nitrogen, argon, etc.) from an air source (e.g., re-circulated air within a building, outdoor air, air pollution, human breath); processing this gaseous mixture of carbon dioxide and other components—according to various chemical techniques and/or in combination with additional components—to form a hydrocarbon precursor; and reacting this hydrocarbon precursor (e.g., via chemical vapor deposition) to form the diamond composition 110, which can be configured to form a diamond product (e.g., a jewelry-grade diamond).

In particular, the method S100 includes: harvesting a low-purity carbon dioxide mixture via direct air capture (e.g., via amine filtration); transforming this low-purity mixture into a high-purity hydrocarbon precursor via a methanation process; and generating diamond crystals from this high-purity hydrocarbon precursor within a diamond reactor (e.g., a chemical vapor deposition reactor) to produce ethically-sourced, lab-grown, carbon-negative, jewelry-grade diamonds, such as described in U.S. patent application Ser. No. 17/314,012, filed on 6 May 2021, which is incorporated in its entirety by this reference.

### 4.1 Air to Carbon Dioxide Mixture

More specifically, Block S120 of the method S100 recites ingesting a first mixture (e.g., a low-purity carbon dioxide mixture) extracted from a first air sample (e.g., via amine filtration), the first mixture including carbon dioxide and a first concentration of impurities (e.g., nitrogen), the amount of carbon dioxide defining a first ratio of carbon-13 isotopes to carbon-12 isotopes. The resulting gaseous mixture (i.e., the first mixture) is a low-purity gaseous mixture of carbon dioxide (e.g., less than 80.0 percent carbon dioxide). This low-purity carbon dioxide mixture also includes concentrations of impurities found in air such as nitrogen, argon, and other gases.

In one implementation, the low purity, gaseous carbon dioxide mixture is extracted from atmospheric air via amine filtration. In particular, in this implementation, an air sample, including a first concentration of carbon dioxide, can be collected during an air capture period. An amount of carbon dioxide can then be extracted from the first air sample via filtration (e.g., amine filtration). This amount of carbon dioxide can then be heated, in a chamber, to generate a carbon dioxide mixture including a second concentration of carbon dioxide greater than the first concentration of carbon dioxide. This carbon dioxide mixture can then be stored in a container for further processing (e.g., at a second location). For example, air can be drawn into a reservoir (e.g., within a carbon capture device) defining an opening through which air enters the reservoir. The reservoir can include a filter arranged within the opening and configured to collect carbon dioxide molecules in the air flowing through the opening while enabling other particles in the air to flow through freely. Once the filter is saturated with carbon dioxide, the filter can be heated (e.g., to temperatures between 95 degrees Celsius and 120 degrees Celsius) to extract carbon dioxide gas from the filter. Upon heating the filter, the gaseous carbon dioxide mixture is released from the filter. This gaseous carbon dioxide mixture can then be collected and stored (e.g., in a container). Later, the gaseous carbon dioxide mixture (e.g., stored in the container) can be ingested for further processing.

In one implementation, direct air capture via amine filtration results in a low-purity gaseous carbon dioxide mixture exhibiting a carbon dioxide concentration between seventy percent and eighty-five percent. The low-purity gaseous carbon dioxide mixture exhibits an impurity concentration between fifteen percent and thirty percent, the impurity concentration including a concentration of nitrogen (e.g., in the form of NX compounds such as nitrogen oxides and/or ammonia). However, nitrogen can be toxic to diamond crystal growth if present in the diamond reactor. Therefore, this initial low purity gaseous carbon dioxide mixture can be further treated to increase the concentration of carbon dioxide and reduce the concentration of impurities in the mixture. In particular, the low purity gaseous carbon dioxide mixture can be purified via a liquefaction technique to reduce the concentration of nitrogen (e.g., in NX compounds) in the carbon dioxide mixture.

Furthermore, Block S122 of the method S100 recites: condensing the first carbon dioxide mixture via liquefaction to remove impurities from the first carbon dioxide mixture to generate a second carbon dioxide mixture including a second concentration of impurities less than the first concentration of impurities. In one implementation, the low purity gaseous carbon dioxide mixture is liquefied at low temperatures (e.g., less than 31 degrees Celsius) and with an applied pressure (e.g., less than 73 bar) to generate a higher purity liquid carbon dioxide mixture. The resulting higher purity liquid mixture of carbon dioxide therefore exhibits a greater concentration of carbon dioxide and lower concentration of impurities (e.g., nitrogen) than the input gaseous carbon dioxide mixture.

This high-purity carbon dioxide mixture—in a liquid state at an outlet of the separation unit—can then be converted from the liquid state to a gaseous state prior to methanation of the high-purity carbon dioxide mixture.

### 4.2 Methanation: Carbon Dioxide Mixture to Hydrocarbon Mixture

The methanation technique in Block S130 of the method S100 recites: in a methanation reactor, mixing the second carbon dioxide with a stream of hydrogen, in the presence of a catalyst, to generate a hydrocarbon mixture including a third concentration of impurities (including carbon dioxide, hydrogen, and water) via methanation of the second carbon dioxide mixture.

In one implementation, the high-purity gaseous carbon dioxide mixture (e.g., greater than 95 percent carbon dioxide concentration) is transferred to a methanation reactor configured to promote a catalytic methanation reaction. This methanation reactor system (e.g., the reactor and the high-purity gaseous carbon dioxide mixture) can be pressurized by introducing a stream of hydrogen gas to the system, which triggers methanation of the high-purity gaseous carbon dioxide mixture. In particular, in this implementation, the high-purity gaseous carbon dioxide mixture can be treated (e.g., mixed) with a stream of hydrogen (e.g., a stream of hydrogen gas), in the methanation reactor, in the presence of a catalyst, to generate a hydrocarbon precursor (e.g., hydrocarbon mixture) via methanation of the high-purity gaseous carbon dioxide mixture. The hydrocarbon precursor can include hydrocarbons (e.g., methane) and impurities such as hydrogen, carbon dioxide, and/or nitrogen (e.g., less than 350 parts-per-million, less than 10 parts-per-million, less than 2 parts-per-billion).

### 4.3 Chemical Vapor Deposition: Hydrocarbon Mixture to Diamond

Additionally, Block S140 of the method S100 recites: in a diamond reactor, exposing the hydrocarbon mixture to a diamond seed to generate a diamond composition 110 via chemical vapor deposition (or “CVD”), the diamond composition 110 defining a second ratio of carbon-13 isotopes to carbon-12 isotopes less than the first ratio. In particular, the high-purity hydrocarbon precursor can be transferred into a CVD reactor (e.g., a vacuum chamber) configured to generate diamond crystals via chemical vapor deposition. For example, a diamond seed can be placed in the CVD reactor. As the hydrocarbon precursor flows into the CVD reactor, the CVD reactor can be heated to very high temperatures (e.g., greater than 800 degrees Celsius). Heating the CVD reactor to these high temperatures causes carbon ions to dispel from the hydrocarbon precursor—which may layer into the diamond seed—thereby enabling the diamond seed to grow into a diamond (e.g., a rough diamond configured to be cut into one or more gemstones).

In one implementation, the high-purity hydrocarbon precursor enters the CVD reactor exhibiting a concentration of methane between 96.0 percent and 99.9999 percent. The CVD reactor can be tuned accordingly based on the concentration of methane and the concentration of impurities (e.g., hydrogen gas, carbon dioxide, argon, nitrogen) of the hydrocarbon precursor. For example, the temperature and pressure in the CVD reactor can be adjusted based on the concentration of methane in the hydrocarbon precursor.

Air present in the gaseous hydrocarbon mixture and CVD reactor can be purged from the CVD reactor to increase efficiency and yield of the reaction. In one implementation, air is purged from the CVD reactor by cycling an inert blend through the CVD reactor. For example, a stream of hydrogen gas can be cycled through the CVD reactor at set intervals throughout the CVD process. Similarly, a stream of an inert gas (e.g., argon) can be cycled through the CVD reactor to act as a carrier and therefore improve a rate of the reaction and a rate of diamond growth.

The CVD reactor can be configured to grow diamonds from a hydrocarbon precursor exhibiting a particular concentration of methane. Therefore, the flowrate of the hydrocarbon precursor into the CVD reactor can be adjusted to control a concentration of methane present in the CVD reactor. For example, if the hydrocarbon precursor exhibits a concentration of methane of 99.9 percent, the flowrate of the hydrocarbon precursor going into the CVD reactor can be lowered. However, if the hydrocarbon precursor exhibits a concentration of methane of 97 percent, then the flowrate of the hydrocarbon precursor going into the CVD reactor can be increased.

In one variation, a stream of hydrogen gas is cycled through the CVD reactor at a set flowrate based on the concentration of hydrogen gas in the hydrocarbon precursor. For example, if the hydrocarbon precursor exhibits a concentration of methane of 99.99 percent and thus a concentration of impurities—including hydrogen gas and carbon dioxide—of 0.01 percent, a stream of hydrogen gas can be cycled through the CVD reactor at a first flowrate based on the relatively low concentration of hydrogen gas present in the hydrocarbon precursor (and the CVD reactor). However, if the hydrocarbon precursor exhibits a concentration of methane of 97 percent and thus a concentration of impurities below 3 percent, a stream of hydrogen gas can be cycled through the CVD reactor at a second flowrate less than the first flowrate based on the relatively high concentration of hydrogen gas already present in the hydrocarbon precursor (and the CVD reactor).

The growth rate of the diamonds in the CVD reactor can be adjusted based on: the concentration of methane in the hydrocarbon precursor entering the CVD reactor; the flow rate of the hydrocarbon precursor can be adjusted to alter the growth rate of the diamonds; and/or the temperature within the CVD reactor.

Therefore, the method S100 can be executed to: extract a carbon dioxide mixture from atmospheric air; convert the carbon dioxide mixture to a hydrocarbon mixture via methanation; and generate diamonds of sufficient quality (e.g., clarity, color, cut, carat weight, type) with particular characteristics (e.g., size, shape, number, position, nature, grade, etc.) that can be inserted into a setting (e.g., jewelry, ornamental setting, decorative setting) to form a diamond product wearable by a user via a carbon-negative process from this carbon dioxide mixture. For example, the diamond composition 110 can form a diamond configured to insert into an ornamental setting to form a diamond product wearable by a user. In another example, the diamond composition 110 can form a diamond exhibiting a type IIA diamond type and configured to insert into a jewelry setting to generate a diamond product wearable by the user. In yet another example, the diamond composition forms a diamond configured to insert into a jewelry setting to generate a diamond product wearable by the user.

### 4.4 Distillation: Regulating the Isotopic Ratio of Carbon-13 to Carbon-12

In one variation, the carbon dioxide mixture can be fed through a distillation column—configured to separate components of the carbon dioxide mixture based on weight of these components—to regulate amounts of carbon-13 isotopes and carbon-12 isotopes present in the carbon dioxide mixture, prior to mixing of the carbon dioxide mixture with the stream of hydrogen in the methanation reactor.

In particular, the carbon dioxide mixture—exhibiting an initial ratio of carbon-13 isotopes to carbon-12 isotopes at an inlet of the distillation column—can be fed into the inlet of the distillation column and collected from a particular outlet of the distillation column (e.g., an upper outlet proximal a top of the distillation column, a lower outlet proximal a bottom of the distillation column), such that the resulting carbon dioxide mixture, collected at the particular outlet, exhibits a ratio of carbon-13 isotopes to carbon-12 isotopes within a target range. For example, a first stream of the carbon dioxide mixture—collected from an upper outlet proximal a top of the distillation column—can exhibit a first ratio of carbon-13 isotopes to carbon-12 isotopes within a first target range (e.g., less than −40.0 parts-per-thousand-versus-PDB-standard). Additionally and/or alternatively, in this example, a second stream of the carbon dioxide mixture—collected from a lower outlet proximal a bottom of the distillation column—can exhibit a second ratio of carbon-13 isotopes to carbon-12 isotopes within a second target range (e.g., greater than −10.0 parts-per-thousand-versus-PDB-standard), ratios of carbon-13 isotopes to carbon-12 isotopes within the second target range greater than ratios of carbon-13 isotopes to carbon-12 isotopes within the first target range.

Therefore, in this variation, by regulating the ratio of carbon-13 isotopes to carbon-12 isotopes of the carbon dioxide mixture to within a particular target range, the diamond composition—formed via chemical vapor deposition of the hydrocarbon mixture generated via methanation of the carbon dioxide mixture—can be configured to exhibit a final ratio of carbon-13 isotopes to carbon-12 isotopes corresponding to the particular target range.

In one implementation: the carbon dioxide mixture can be converted into a liquid carbon dioxide mixture via liquefaction, as described above, and this liquid carbon dioxide mixture can be conveyed through the distillation column to regulate amounts of carbon-13 isotopes and carbon-12 isotopes. At an inlet of the distillation column, the liquid carbon dioxide mixture exhibits an initial ratio of carbon-13 isotopes to carbon-12 isotopes. At an outlet of the distillation column, the liquid carbon dioxide mixture exhibits a ratio of carbon-13 isotopes to carbon-12 isotopes within a target range.

More specifically, at the outlet of the distillation column, an amount of the liquid carbon dioxide mixture can be collected and exhibits a ratio of carbon-13 isotopes to carbon-12 isotopes within a target range. Further, the carbon dioxide mixture—collected from the outlet of the distillation column—can be conveyed through an absorption unit to remove impurities (e.g., nitrogen) present in the carbon dioxide mixture, such as in response to the concentration of impurities in the carbon dioxide mixture exceeding a threshold concentration of impurities (e.g., one percent, five percent). The resulting carbon dioxide mixture can therefore: exhibit a ratio of carbon-13 isotopes to carbon-12 isotopes within the target range; include a concentration of impurities less than the threshold concentration of impurities; and include a concentration of carbon dioxide exceeding a threshold concentration of carbon dioxide (e.g., 95 percent, 99 percent).

In one implementation, Blocks S124 and S126 of the method S100 recite: conveying the second mixture through a distillation column to regulate an initial ratio of carbon-13 isotopes to carbon-12 isotopes present in the second mixture, at an inlet of the distillation column, to within: a first target range at a first outlet of the distillation column, defining a first outlet height, to generate a first fractionated mixture including carbon dioxide; and a second target range at a second outlet of the distillation column, defining a second outlet height less than the first outlet height, to generate a second fractionated mixture including carbon dioxide, ratios within the second target range exceeding ratios within the first target range. In this step, the second mixture (e.g., high purity carbon-dioxide mixture) is conveyed through a distillation column to regulate the ratio of carbon-13 isotopes to carbon-12 isotopes present in the resulting fractionated mixture to within a target range corresponding to an outlet height of the distillation column.

In one implementation, gravity sorts the second mixture by weight—such that the heaviest impurities (e.g., carbon-13 isotopes, nitrogen) sink to the base of the distillation column and the lightest impurities (e.g., carbon-12 isotopes) float to the top of the distillation column—to generate a fractionated mixture, including carbon dioxide, exhibiting a controlled ratio of carbon 13-isotopes to carbon-12 isotopes within a target range. In particular, at a maximum outlet height of the distillation column, the target range represents a high purity fractionated mixture (e.g., lower concentration of impurities) including a relatively high concentration of carbon-12 isotopes and a relatively low concentration of carbon-13 isotopes. Alternatively, at a minimum outlet height of the distillation column, the target range represents a less pure fractionated mixture (e.g., higher concentration of impurities), including a relatively low concentration of carbon-12 isotopes and a relatively high concentration of carbon-13 isotopes.

For example, a first fractionated mixture can be collected at the maximum outlet height of the distillation column and exhibit a first ratio of carbon-13 isotopes to carbon-12 isotopes within a first target range (e.g., between −60 parts-per-thousand-versus-PDB-standard and −20 parts-per-thousand-versus-PDB-standard). During a first processing period in a methanation reactor, the first fractionated mixture (e.g., high purity fractionated mixture) can be mixed with a first stream of hydrogen to generate a first hydrocarbon mixture including hydrocarbons (e.g., via methanation). Then, the first hydrocarbon mixture can be exposed to a first diamond seed within a diamond reactor to generate a first diamond including carbon (e.g., via chemical vapor deposition) and exhibiting a first ratio of carbon-13 isotopes to carbon-12 isotopes (e.g., less than −10 parts-per-thousand-versus-PDB-standard, less than −20 parts-per-thousand-versus-PDB-standard, less than −50 parts-per-thousand-versus-PDB-standard) corresponding to the first target range.

Similarly, a second fractionated mixture can be collected at the minimum outlet height of the distillation column and exhibit a second ratio of carbon-13 isotopes to carbon-12 isotopes within a second target range (e.g., between −12 parts-per-thousand-versus-PDB-standard and zero parts-per-thousand-versus-PDB-standard). During a second processing period in the methanation reactor, the second fractionated mixture (e.g., less pure fractionated mixture) can be mixed with a second stream of hydrogen to generate a second hydrocarbon mixture including hydrocarbons (e.g., via methanation). Then, the second hydrocarbon mixture can be exposed to a second diamond seed within the diamond reactor to generate a second diamond including carbon and exhibiting a second ratio of carbon-13 isotopes to carbon-12 isotopes (e.g., exceeding −10 parts-per-thousand-versus-PDB-standard, exceeding −5 parts-per-thousand-versus-PDB-standard, exceeding zero parts-per-thousand-versus-PDB-standard) exceeding the first ratio and corresponding to the second target range.

### 5. Carbon Isotopic Signature

Generally, stable isotopic compositions of light (e.g., low mass) elements—such as carbon, Oxygen, hydrogen, nitrogen, Sulfur etc.—are reported as “delta” (d) values in parts per thousand (i.e., per mil, %; per mill, %; or per mille, %) enrichments or depletions relative to a standard known composition (or “established reference material”). The standard for carbon stable isotopes is the Pee Dee Belemnite standard (or “PDB standard”).

The diamond composition 110 can include a mixture of carbon isotopes (e.g., carbon-13 isotopes and carbon-12 isotopes and/or carbon-14 isotopes) defining a particular isotopic signature (or “δ¹³C”). This particular isotopic signature is a measure of the ratio of stable isotopes (e.g., carbon-13 isotopes and carbon-12 isotopes) of the diamond composition 110. Additionally, the isotopic signature is reported as a “delta” (d) value in parts-per-thousand-versus-PDB-standard (e.g., −10.0 parts-per-thousand-versus-PDB-standard, 1 parts-per-thousand-versus-PDB-standard), as described below.

### 5.1 Variations in Carbon Isotope Concentration

In one implementation, the diamond composition 110 can include carbon isotopic concentrations similar to natural diamonds (e.g., ground-sourced diamonds). By sourcing carbon from the air—rather than the ground—the diamond composition 110 is less depleted in carbon-13 than traditional lab-grown diamonds (e.g., ground-sourced HPHT and/or CVD diamonds) which may be more heavily depleted in carbon-13 compared to the diamond composition 110 and natural diamonds (e.g., ground-sourced diamonds).

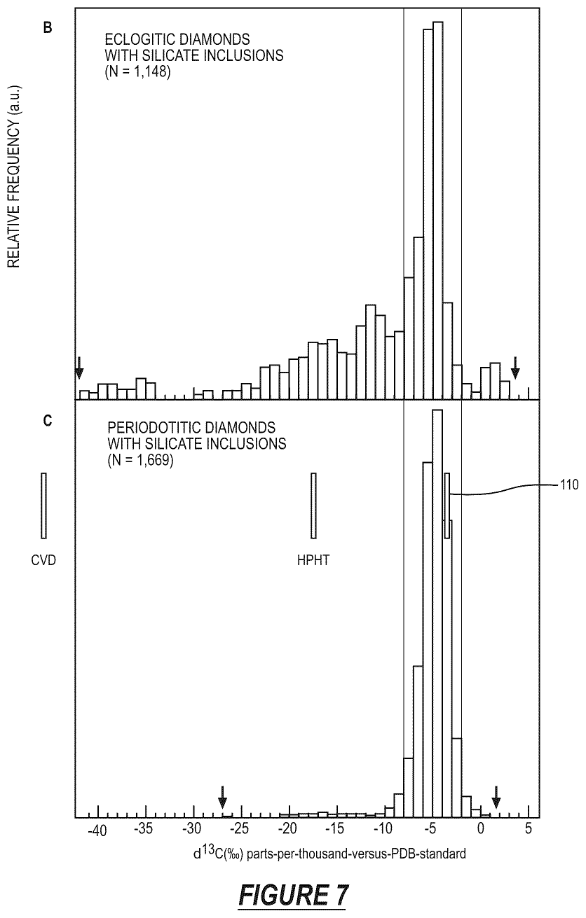

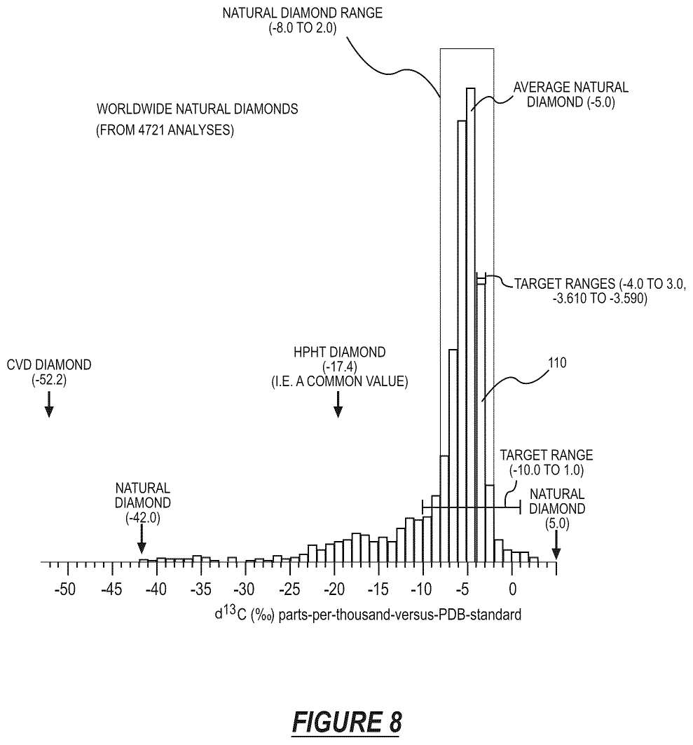

In particular, natural diamonds (e.g., ground-sourced diamonds) are more enriched in carbon-13 than traditional lab-grown diamonds due to natural decaying of carbon-14 isotopes into carbon-13 isotopes over time. Alternatively, traditional lab-grown diamonds, including carbon sourced from the ground, are sourced in the form of hydrocarbons (e.g., organic carbon) and are more depleted in carbon-13 than natural diamonds (e.g., ground-sourced diamonds). For example, a traditional lab-grown CVD diamond is formed in a chemical vapor deposition reactor from hydrocarbons sourced from the ground. These hydrocarbons include a greater proportion of organic carbon than inorganic carbon, which is more depleted in carbon-13 than inorganic carbon. After chemical vapor deposition of these hydrocarbons, the resulting CVD diamonds include more organic carbon than inorganic carbon. More specifically, a natural, ground-sourced diamond includes a greater proportion of inorganic carbon than organic carbon, which is less depleted in carbon-13 than organic carbon, compared to a standard CVD diamond (e.g., a lab-grown CVD diamond). Therefore, the CVD diamonds exhibit greater carbon-13 depletion, and thus a more negative carbon isotopic signature than most natural diamonds (e.g., ground-sourced diamonds), as shown in FIGS. 7 and 8. For example, a natural diamond can exhibit an average isotopic signature—defining a ratio of an amount of carbon-13 isotopes to an amount of carbon-12 isotopes—of −5.0 parts-per-thousand-versus-PDB-standard. Alternatively, a CVD diamond can exhibit an isotopic signature of −52.2 parts-per-thousand-versus-PDB-standard.

Alternatively, a diamond formed of the diamond composition 110 via execution of Blocks of the method S100—including chemical vapor deposition of hydrocarbons including carbon sourced from air—can be configured to exhibit a similar ratio of carbon-13 isotopes to carbon-12 isotopes as a natural diamond (e.g., ground-sourced diamond). In particular, the diamond composition 110 can include carbon sourced from air and including a first amount of carbon-13 isotopes and a second amount of carbon-12 isotopes. The diamond composition 110 can be formed via CVD of a diamond seed and can exhibit an isotopic signature defining a first ratio of the first amount of carbon-13 isotopes to the second amount of carbon-12 isotopes within a target range (e.g., between −10.0 parts-per-thousand-versus-PDB-standard and 1.0 parts-per-thousand-versus-PDB-standard, between 8.0-parts-per-thousand-versus-PDB-standard and −2.0 parts-per-thousand-versus-PDB-standard) corresponding to (e.g., including, within a threshold deviation of) ratios of amounts of carbon-13 isotopes to carbon-12 isotopes exhibited by natural diamonds (e.g., ground-sourced diamonds). Thus, the isotopic ratio of the diamond composition 110 can fall within a target range configured to match and/or overlap with isotopic ratios of natural diamonds (e.g., ground-sourced diamonds). Further, the diamond composition 110 can be configured to exhibit this isotopic signature defining the first ratio within the target range, such that ratios within the target range exceed ratios exhibited by standard CVD diamonds.

In one example, the diamond composition 110 is formed via CVD of a diamond seed exposed to a gaseous hydrocarbon mixture—including hydrocarbons including carbon sourced from air—formed via methanation of a carbon dioxide mixture extracted from a sample of air and including carbon dioxide and impurities. The diamond composition 110 can exhibit an isotopic signature defining a first ratio of the first amount of carbon-13 isotopes to the second amount of carbon-12 isotopes exceeding a threshold ratio of −10.0 parts-per-thousand-versus-PDB-standard. In particular, the carbon dioxide mixture can exhibit an initial ratio of initial amounts of carbon-13 isotopes to carbon-12 isotopes and the gaseous hydrocarbon mixture can exhibit a secondary ratio of secondary amounts of carbon-13 isotopes to carbon-12 isotopes, the secondary ratio less than the initial ratio of the carbon dioxide mixture. The resulting diamond composition 110—formed via CVD of the gaseous hydrocarbon mixture—can then exhibit the first ratio greater than the initial ratio of the carbon dioxide mixture and the secondary ratio of the gaseous hydrocarbon mixture.

In the preceding example, a sample of atmospheric air can exhibit a first isotopic ratio of carbon-13 isotopes to carbon-12 isotopes of approximately 7.0 parts-per-thousand-versus-PDB-standard. Upon extraction of the low-purity carbon dioxide mixture from the sample of atmospheric air (e.g., via amine filtration), the low-purity carbon dioxide mixture can exhibit a second isotopic ratio of −5.0 parts-per-thousand-versus-PDB-standard. The carbon-capture process may thus decrease the concentration of carbon-13 present in the mixture.

The low-purity carbon dioxide mixture can then be purified via liquefaction to reduce a concentration of impurities (e.g., nitrogen compounds) present in the low-purity carbon dioxide mixture, thereby generating a high-purity carbon dioxide mixture. This high-purity carbon dioxide mixture can then be mixed with a stream of hydrogen gas in a methanation reactor, in the presence of a catalyst, to generate a hydrocarbon mixture. This hydrocarbon mixture can exhibit a third isotopic ratio of carbon-13 isotopes to carbon-12 isotopes of −7.0 parts-per-thousand-versus-PDB-standard. Thus, the methanation process (e.g., methanation of the high-purity carbon dioxide mixture) may again decrease the concentration of carbon-13 present in the mixture.

The resulting hydrocarbon mixture can then be purified (e.g., via liquefaction, via a set of filters) to reduce the concentration of impurities present in the hydrocarbon mixture. Then, the purified hydrocarbon mixture can be deposited in a diamond reactor containing a set of diamond seeds. The purified hydrocarbon mixture can then interact with the set of diamond seeds, in the diamond reactor, to generate a set of diamonds via chemical vapor deposition. The resulting set of diamonds can exhibit a fourth isotopic ratio of carbon-13 isotopes to carbon-12 isotopes of −3.0 parts-per-thousand-versus-PDB-standard. Thus, the CVD process may increase the concentration of carbon-13 isotopes present in the resulting diamonds compared to the hydrocarbon mixture.

Therefore, the carbon-capture process can decrease the concentration of carbon-13 present in the mixture, the methanation process can also further decrease the concentration of carbon-13 present in the mixture, and the CVD process can increase the concentration of carbon-13 isotopes present in the resulting diamonds compared to the hydrocarbon mixture and the low-purity carbon dioxide mixture.

### 5.1.1 Carbon-14 Isotope Concentration

In one variation, the diamond composition 110 can include a concentration of carbon-14 isotopes distinct from natural diamonds (e.g., ground-sourced diamonds). Further, by sourcing carbon from the air—rather than the ground—the diamond composition 110 is less depleted in carbon-14 than traditional lab-grown diamonds (e.g., ground-sourced HPHT and/or CVD diamonds) which may be more heavily depleted in carbon-14 compared to the diamond composition 110.

In particular, natural diamonds (e.g., ground-sourced diamonds) are heavily depleted in carbon-14 due to natural decaying of carbon-14 isotopes into carbon-13 isotopes over time. More specifically, an age of natural, ground-source diamonds generally greatly exceeds a half-life of carbon-14 isotopes, thus leading to natural diamonds (e.g., ground-sourced diamonds) enriched in carbon-13 and heavily depleted in carbon-14. However, carbon-14 is produced naturally in the atmosphere (e.g., in the upper layers of the troposphere and/or stratosphere) and therefore present in carbon dioxide in the atmosphere. Therefore, by sourcing carbon from carbon dioxide found in atmospheric air, the diamond composition 110 can exhibit a concentration of carbon-14 isotopes exceeding a concentration of carbon-14 isotopes found in natural diamonds (e.g., ground-sourced diamonds). Similarly, traditional lab-grown diamonds (e.g., ground-sourced HPHT and/or CVD diamonds) are heavily depleted in carbon-14 due to this decaying of carbon-14 isotopes into carbon-13 isotopes over time.

For example, the diamond composition 110 can include carbon sourced from air which includes a first amount of carbon-13 isotopes, a second amount of carbon-12 isotopes, and a third amount of carbon-14 isotopes. A diamond formed of the diamond composition 110 can exhibit a carbon-14 concentration within a carbon-14 concentration range (e.g., less than a carbon-13 concentration range), the carbon-14 concentration within the carbon-14 concentration range is greater than an average carbon-14 concentration exhibited by natural diamonds (e.g., ground-sourced diamonds).

Therefore, in this variation, the diamond composition 110 can exhibit a carbon-14 concentration greater than carbon-14 concentrations of both natural diamonds (e.g., ground-sourced diamonds) and traditional lab-grown diamonds (e.g., ground-sourced HPHT and/or CVD diamonds). The diamond composition 110 can thus be distinguished—and confirmed as a diamond generated from carbon sourced from air—from these natural, ground-sourced and/or traditional, lab-grown diamonds via analysis (e.g., via mass spectrometry) of the carbon-14 concentration.

### 5.2 Isotopic Signature Range

As shown in FIG. 8, the diamond composition 110—forming a diamond—can exhibit an isotopic signature (or “δ¹³C”) defining a ratio (or “isotopic ratio”) of carbon-12 isotopes to carbon-13 isotopes falling within a target isotopic signature range (e.g., between −10.0 parts-per-thousand-versus-PDB-standard and 1.0 parts-per-thousand-versus-PDB-standard, between −8.0 parts-per-thousand-versus-PDB-standard and −2.0 parts-per-thousand-versus-PDB-standard, exceeding −10.0 parts-per-thousand-versus-PDB-standard) corresponding to average isotopic signatures of natural diamonds (e.g., ground-sourced diamonds), as described above.

Additionally and/or alternatively, the diamond composition 110 can be configured to exhibit an isotopic signature defining a ratio of carbon-12 isotopes to carbon-13 isotopes falling within a comprehensive isotopic signature range (e.g., between −42.0 parts-per-thousand-versus-PDB-standard and 5.0 parts-per-thousand-versus-PDB-standard). The comprehensive isotopic signature range includes average isotopic signatures of natural diamonds (e.g., ground-sourced diamonds), and traditional lab-grown diamonds (e.g., ground-sourced HPHT and/or CVD diamonds).

However, the diamond composition 110—forming a diamond—can exhibit an isotopic signature (or “δ¹³C”) defining an isotopic ratio of carbon-12 isotopes to carbon-13 isotopes falling within narrower ranges and/or exceeding or falling below a threshold ratio within this comprehensive isotopic signature range (e.g., between −42.0 parts-per-thousand-versus-PDB-standard and 5.0 parts-per-thousand-versus-PDB-standard).

### 5.2.1 Target Isotopic Signature Range

In one implementation, the diamond composition 110 can be generated via the method S100 and include carbon sourced from air, which includes a first amount of carbon-12 isotopes and a second amount of carbon-13 isotopes. In this implementation, the diamond composition 110 can exhibit an isotopic signature defining a first ratio of the first amount of carbon-13 isotopes to the second amount of carbon-12 isotopes within a first target range between −10.0 parts-per-thousand-versus-PDB-standard and 1.0 parts-per-thousand-versus-PDB-standard.

In one example, the diamond composition 110 can exhibit the first ratio of the first amount of carbon-13 isotopes to the second amount of carbon-12 isotopes greater than −5.0 parts-per-thousand-versus-PDB-standard and within the first target range.

In another example, the diamond composition 110 can exhibit the first ratio of the first amount of carbon-13 isotopes to the second amount of carbon-12 isotopes within a second target range, falling within the first target range, between −4.0 parts-per-thousand-versus-PDB-standard and −3.0 parts-per-thousand-versus-PDB-standard.

In yet another example, the diamond composition 110 can exhibit the first ratio of the first amount of carbon-13 isotopes to the second amount of carbon-12 isotopes within a third target range, falling within the first target range and the second target range, between −3.610 parts-per-thousand-versus-PDB-standard and −3.590 parts-per-thousand-versus-PDB-standard.

In one variation, the diamond composition 110 can exhibit an isotopic signature within an alternative target range, falling within this first target range, as a function of time, location, and/or Blocks of the method S100, further described below. The isotopic signature can vary based on the particular time period the carbon sample was extracted from air (e.g., 2010 with an isotopic signature of −5.0 parts-per-thousand-versus-PDB-standard, 2022 with an isotopic signature of −7.5 parts-per-thousand-versus-PDB-standard) and based on the geographic location the carbon sample was extracted from air (e.g., at the beach with an isotopic signature of −4.0 parts-per-thousand-versus-PDB-standard, outside of a lab facility with an isotopic signature of −3.7 parts-per-thousand-versus-PDB-standard). Additionally, the isotopic signature can vary with variations of Blocks of the method S100 such as the processes of liquefaction, CVD, and/or methanation.

### 5.2.2 Isotopic Signature Range+Threshold Ratio

In another variation, the diamond composition 110 can be generated via the method S100 and includes carbon sourced from air, which includes a first amount of carbon-13 isotopes, a second amount of carbon-12 isotopes, and a third amount of carbon-14 isotopes. The diamond composition 110 can also exhibit an isotopic signature defining a first ratio of the first amount of carbon-13 isotopes to the second amount of carbon-12 isotopes within a first target range between −4.0 parts-per-thousand-versus-PDB-standard and −3.0 parts-per-thousand-versus-PDB-standard.

In one example, the diamond composition 110 can exhibit the first ratio of the first amount of carbon-13 isotopes to the second amount of carbon-12 isotopes within a second target range, falling within the first target range, between −3.610 parts-per-thousand-versus-PDB-standard and −3.590 parts-per-thousand-versus-PDB-standard.

Additionally or alternatively, the diamond composition 110 can exhibit a ratio of the first amount of carbon-13 isotopes to the second amount of carbon-12 isotopes exceeding a threshold ratio, instead of falling within a target range. For example, the diamond composition 110 can exhibit the first ratio of the first amount of carbon-13 isotopes to the second amount of carbon-12 isotopes exceeding a threshold ratio of −10.0 parts-per-thousand-versus-PDB-standard.

Therefore, the diamond composition 110 can exhibit an isotopic signature within a narrow range and/or greater than a threshold ratio. Simultaneously, the isotopic signature can be greater than an average isotopic signature of both natural diamonds (e.g., ground-sourced diamonds) and traditional lab-grown diamonds (e.g., ground-sourced HPHT and/or CVD diamonds) within the comprehensive isotopic signature range.

### 5.3 Regulated Isotopic Signature Range

In one variation, the carbon dioxide mixture can be conveyed through a distillation column: to regulate a ratio of an amount of carbon-13 isotopes to an amount of carbon-12 isotopes to within a first target range, as described above. The resulting diamond composition 110 can thus be configured to exhibit a final ratio of a first amount of carbon-13 isotopes to a second amount of carbon-12 isotopes within a second target range corresponding to the first target range defined for the carbon dioxide mixture.

In one implementation, the resulting diamond composition 110 can be configured to exhibit an isotopic signature defining a final ratio of the first amount of carbon-13 isotopes to the second amount of carbon-12 isotopes within a target range between −60.0 parts-per-thousand-versus-PDB-standard to 5.0 parts-per-thousand-versus-PDB-standard. Additionally and/or alternatively, in yet another implementation, the resulting diamond composition 110 can be configured to exhibit an isotopic signature defining a final ratio of the first amount of carbon-13 isotopes to the second amount of carbon-12 isotopes within a target range between −10.0 parts-per-thousand-versus-PDB-standard to 5.0 parts-per-thousand-versus-PDB-standard. In each of these implementations, the target range can be expanded or decreased by adjusting parameters and operation of the distillation column.

For example, the diamond composition 110 can be configured to exhibit an isotopic signature defining a final ratio of the first amount of carbon-13 isotopes to the second amount of carbon-12 isotopes within a target range between −20.0 parts-per-thousand-versus-PDB-standard to 5.0 parts-per-thousand-versus-PDB-standard. In this example, the distillation column can include a set of levels, each level in the set of levels defining an outlet height, in a set of outlet heights, of the distillation column and corresponding to a volume, in a set of volumes, of the carbon dioxide mixture in the distillation column. Then, a first volume of the carbon dioxide mixture can be collected from a first level in the set of levels—at a maximum outlet height (e.g., top of the distillation column) in the set of outlet heights—of the distillation column. The first volume of the carbon dioxide mixture can exhibit a first target ratio of carbon-13 isotopes to carbon-12 isotopes falling within a first target range between −20.0 parts-per-thousand-versus-PDB-standard and −10.0 parts-per-thousand-versus-PDB-standard. A second volume of the carbon dioxide mixture can be collected from a second level in the set of levels—at a minimum outlet height (e.g., base of the distillation column) in the set of outlet heights—of the distillation column. The second volume of the carbon dioxide mixture can exhibit a second target ratio of carbon-13 isotopes to carbon-12 isotopes, greater than the first target ratio, and falling within a second target range between 1.0 parts-per-thousand-versus-PDB-standard and 5.0 parts-per-thousand-versus-PDB-standard.

Lastly, a third volume of the carbon dioxide mixture can be collected from a third level, between the first level and the second level, at a first outlet height between the maximum outlet height (e.g., top of the distillation column) and the minimum outlet height (e.g., base of the distillation column) of the distillation column. The third volume of the carbon dioxide mixture can define a third target ratio of carbon-13 isotopes to carbon-12 isotopes, greater than the first target ratio and less than the second target ratio, falling within a third target range between −10.0 parts-per-thousand-versus-PDB-standard and 1.0 parts-per-thousand-versus-PDB-standard. Subsequently, Blocks of the method S100 can be executed to generate the diamond composition 110 from one of and/or a mixture of these volumes of the carbon dioxide mixture to exhibit an isotopic signature defining a final ratio of the first amount of carbon-13 isotopes to the second amount of carbon-12 isotopes within the first target range between −20.0 parts-per-thousand-versus-PDB-standard to 5.0 parts-per-thousand-versus-PDB-standard.

Additionally, in the preceding example, the diamond composition 110 can be formed from a mixture of these volumes of the carbon dioxide mixture (in the preceding example) and exhibit the final ratio of the first amount of carbon-13 isotopes to the second amount of carbon-12 isotopes within a fourth target range, falling within the target range, between −4.0 parts-per-thousand-versus-PDB-standard and −3.0 parts-per-thousand-versus-PDB-standard.

In another variation, Blocks of the method S100 can be executed to generate a carbon dioxide mixture. The carbon dioxide mixture can be conveyed through the distillation column to regulate an initial ratio of carbon-13 isotopes to carbon-12 isotopes present in the carbon dioxide mixture, at the inlet of the distillation column, to within a first target range at a first outlet and a second target range at a second outlet.

For example, the carbon dioxide mixture can be conveyed through the distillation column to regulate an initial ratio of carbon-13 isotopes to carbon-12 isotopes present in the carbon dioxide mixture, at the inlet of the distillation column, to within: a first target range, at the first outlet, defining a first outlet height, of the distillation column, between −20.0 parts-per-thousand-versus-PDB-standard and −4.0 parts-per-thousand-versus-PDB-standard; and a second target range, at the second outlet, defining a second outlet height (e.g., less than the first outlet height) of the distillation column, between −4.0 parts-per-thousand-versus-PDB-standard and −3.0 parts-per-thousand-versus-PDB-standard.

Alternatively, Blocks of the method S100 can be executed to convey the carbon dioxide mixture through the distillation column to regulate a target ratio of carbon-13 isotopes to carbon-12 isotopes present in the carbon dioxide mixture to within a target range of ratios exhibited by natural diamonds (e.g., ground-sourced diamonds). For example, at a first time, the carbon dioxide mixture can be collected at a maximum outlet height (e.g., top of the distillation column) of the distillation column from the outlet to regulate the target ratio of carbon-13 isotopes to carbon-12 isotopes to within a first target range between −8.0-parts-per-thousand-versus-PDB-standard and −2.0 parts-per-thousand-versus-PDB-standard, ratios within the first target range corresponding to ratios of amounts of carbon-13 isotopes to amounts of carbon-12 isotopes exhibited by natural diamonds (e.g., ground-sourced diamonds); and, at a second time, the carbon dioxide mixture can be collected at a minimum outlet height (e.g., base of the distillation column) of the distillation column from the outlet to regulate the target ratio of carbon-13 isotopes to carbon-12 isotopes to within a second target range, falling within the first target range, between −4.0-parts-per-thousand-versus-PDB-standard and −3.0 parts-per-thousand-versus-PDB-standard.

Therefore, the distillation column can be configured to regulate amounts of carbon-13 isotopes to carbon-12 isotopes exhibiting a target ratio within a target range corresponding to outlet heights of the distillation column. Intermediate mixtures (e.g., carbon dioxide, fractionated mixtures, mixture of carbon dioxide and impurities etc.) can then be selected from a particular outlet height of the distillation column and Blocks of the method S100 can be implemented to control the final ratio of the first amount of carbon-13 isotopes to the second amount of carbon-12 isotopes within a first target range—exhibited by the diamond composition 110—corresponding to the target ratio exhibited by the intermediate mixture.

### 5.4 Conductivity+Isotopic Signature

Generally, a distillation column and amine filtration can be configured to reduce and/or remove impurities or defects and Blocks of the method S100 can be executed to generate a diamond formed of the diamond composition 110 exhibiting reduced impurity or defect scattering.

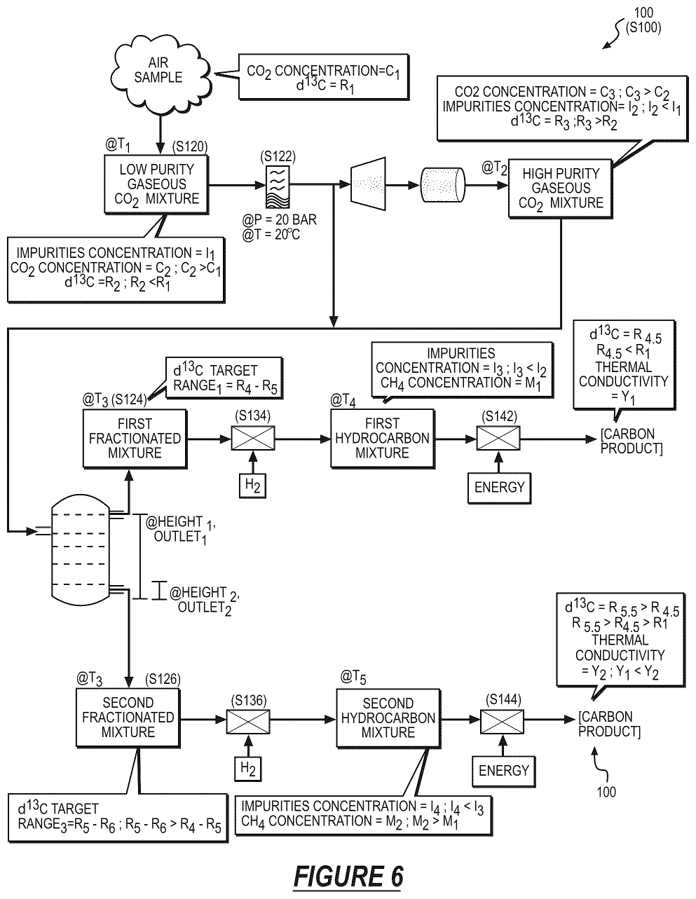

In one variation, Blocks of the method S100 can be executed to regulate a ratio of an amount of carbon-13 isotopes to an amount of carbon-12 isotopes present in the diamond composition 110 toward a target ratio via a distillation column and to generate a diamond composition 110 exhibiting a target thermal conductivity, as shown in FIG. 6. More specifically, in this variation, Blocks of the method S100 can be executed to: purify upstream materials—such as the carbon dioxide mixture—via amine filtration and/or feeding of these materials through a distillation column configured to reduce and/or remove impurities from these upstream materials; and generate a diamond formed of the diamond composition 110 exhibiting reduced impurity and/or defect scattering. A diamond formed of the diamond composition 110 can then exhibit a target thermal conductivity proportional to a purity of the diamond (e.g., minimal to no impurities) and within a thermal conductivity range exhibited by natural diamonds (e.g., ground-sourced diamonds).

In particular, the diamond composition 110 can include carbon—including a first amount of carbon-13 isotopes and a second amount of carbon-12 isotopes—sourced from a hydrocarbon mixture including hydrocarbons and formed via methanation of a carbon dioxide mixture. The carbon dioxide mixture can be conveyed through a separation unit to remove impurities and the resulting mixture can be further conveyed through a distillation column to regulate amounts of carbon-13 isotopes and carbon-12 isotopes in the mixture. The diamond composition 110 can exhibit an isotopic signature defining a final ratio of the first amount of carbon-13 isotopes to the second amount of carbon-12 isotopes within a first target range corresponding to the target ratio exhibited by the carbon dioxide mixture.

In one implementation, different subvolumes of the carbon dioxide mixture in a distillation column can be collected from a set of outlets—each outlet defining a particular outlet height, such that each subvolume of the carbon dioxide mixture exhibits a particular target ratio of carbon-13 isotopes to carbon-12 isotopes. Each subvolume of the carbon dioxide mixture can then be processed according to Blocks of the method S100 to form a set of diamond compositions 100 including a range of final ratios of carbon-13 isotopes to carbon-12 isotopes, and thereby exhibiting a range of thermal conductivities corresponding to the range of final ratios.

For example, the carbon dioxide mixture can include: a first subvolume exhibiting a first target ratio of carbon-13 isotopes to carbon-12 isotopes at a first outlet, in a set of outlets, of the distillation column, the first outlet defining a first outlet height; and a second subvolume exhibiting a second target ratio of carbon-13 isotopes to carbon-12 isotopes at a second outlet, in the set of outlets, of the distillation column, the second outlet defining a second outlet height less than the first outlet height. The hydrocarbon mixture includes: a third subvolume formed via methanation of the first subvolume of the carbon dioxide mixture; and a fourth subvolume formed via methanation of the second subvolume of the carbon dioxide mixture. The diamond composition 110 includes a first diamond composition: formed via chemical vapor deposition of a first diamond seed exposed to the third subvolume of the hydrocarbon mixture; and exhibiting a first isotopic signature defining a first final ratio of carbon-13 isotopes to carbon-12 isotopes. The diamond composition 110 also includes a second diamond composition: formed via chemical vapor deposition of a second diamond seed exposed to the fourth subvolume of the hydrocarbon mixture; and exhibiting a second isotopic signature defining a second final ratio of carbon-13 isotopes to carbon-12 isotopes. The first diamond composition exhibits a first thermal conductivity, and the second diamond composition exhibits a second thermal conductivity less than the first thermal conductivity.

In another example, a diamond formed of the diamond composition 110 is characterized by a first amount of thermal conductivity within a target thermal conductivity range between 2,200 watts-per-meter-kelvin and 3,000 watts-per-meter-kelvin, amounts within the target thermal conductivity range greater than amounts of thermal conductivity exhibited by natural diamonds (e.g., 2,200 watts-per-meter-kelvin, 2,400 watts-per-meter-kelvin). Accordingly, the diamond composition 110 exhibits the isotopic signature defining the final ratio of the first amount of carbon-13 isotopes to the second amount of carbon-12 isotopes within the first target range greater than −10.0 parts-per-thousand-versus-PDB-standard, ratios within the first target range corresponding to ratios of amounts of carbon-13 isotopes to amounts of carbon-12 isotopes exhibited by natural diamonds (e.g., ground-sourced diamonds).

In yet another example, a diamond formed of the diamond composition 110 is characterized by a first amount of thermal conductivity within a target thermal conductivity range between 1,000 watts-per-meter-kelvin and 2,400 watts-per-meter-kelvin, amounts within the target thermal conductivity range corresponding to ratios of amounts of thermal conductivity exhibited by natural diamonds (e.g., ground-sourced diamonds). Accordingly, the diamond composition 110 exhibits the isotopic signature defining the final ratio of the first amount of carbon-13 isotopes to the second amount of carbon-12 isotopes within the first target range between −10.0 parts-per-thousand-versus-PDB-standard and 2.0 parts-per-thousand-versus-PDB-standard.

Additionally or alternatively, Blocks of the method S100 can be executed to regulate a ratio of an amount of carbon-13 isotopes to an amount of carbon-12 isotopes present in the diamond composition 110 toward a target ratio via a distillation column and to generate a diamond composition 110 exhibiting a target electrical conductivity. In particular, Blocks of the method S100 can be executed to: generate a diamond formed of the diamond composition 110 exhibiting reduced impurity and/or defect scattering. A diamond formed of the diamond composition 110 can then exhibit a target electrical conductivity proportional to a purity of the diamond (e.g., minimal to no impurities) and within an electrical conductivity range (e.g., between 2,200 watts-per-meter-kelvin and 2,400 watts-per-meter-kelvin) exhibited by natural diamonds (e.g., ground-sourced diamonds).

Therefore, the thermal conductivity and/or electrical conductivity of the diamond composition 110 is proportional to the isotopic signature defining a ratio of carbon-13 isotopes to carbon-12 isotopes and can be regulated via purification processes (e.g., amine filtration, distillation column). The diamond composition 110 can also exhibit thermal conductivity and/or electrical conductivity and ratios of carbon-13 isotopes to carbon-12 isotopes greater than and/or within the range of thermal conductivities and/or electrical conductivities and ratios exhibited by natural diamonds (e.g., ground-sourced diamonds).

### 5.4.1 Material Properties+Isotopic Signature

In one implementation, a diamond product (e.g., an electronic device, a semiconductor) formed of the diamond composition 110 can exhibit properties (e.g., material, electrical, optical, magnetic, physical, thermal) proportional to the thermal conductivity and isotopic signature. In particular, a semiconductor, including a diamond formed of the diamond composition 110, can exhibit hole mobility, defect mobility, and a lattice structure proportional to a thermal conductivity and an isotopic ratio of the diamond—regulated via purification processes (e.g., amine filtration, distillation column) to within a target range.

In one variation, Blocks of the method S100 can be executed to regulate amounts of carbon-13 isotopes to carbon-12 isotopes via a distillation column to exhibit a target ratio and to generate a diamond composition 110 exhibiting a target thermal conductivity, as shown in FIG. 6. Then, a semiconductor including a diamond formed of the diamond composition 110 can be characterized by a hole mobility (i.e., movement of a hole and/or absence of an electron through a semiconductor when an electric field is applied), a defect mobility (e.g., vacancy mobility, impurities), and a lattice structure (e.g., arrangement of ions, atoms, or particles within the crystal structure of the diamond) corresponding to the target thermal conductivity.

For example, a diamond formed of the diamond composition 110 can be regulated via purification processes (e.g., amine filtration, distillation column) to characterize the diamond composition 110 with a hole mobility within a target hole mobility range (e.g., between 1,500 square-centimeter-per-volt-second and 4,000 square-centimeter-per-volt-second) corresponding to a thermal conductivity within a target thermal conductivity range (e.g., between 1,000 watts-per-meter-kelvin and 2,400 watts-per-meter-kelvin). Accordingly, the diamond composition 110 can exhibit an isotopic signature defining a final ratio of a first amount of carbon-13 isotopes to a second amount of carbon-12 isotopes within a corresponding target range between −10.0 parts-per-thousand-versus-PDB-standard and 2.0 parts-per-thousand-versus-PDB-standard.

Therefore, a distillation column and/or amine filtration can be configured to reduce and/or remove impurities to increase the lattice structure of a diamond formed of the diamond composition 110. Blocks of the method S100 can be executed to generate a diamond formed of the diamond composition 110 with reduced impurity scattering and increased lattice structure to increase the hole mobility and defect mobility of the diamond within a diamond product (e.g., semiconductor).

However, a diamond product including a diamond formed of the diamond composition 110 can exhibit an isotopic signature, thermal conductivity, electrical conductivity, and properties (e.g., material, electrical, optical, magnetic) regulated via any other processes.

### 5.5 Location+Time

In one implementation, the diamond composition 110 defines a particular isotopic signature that can be predictably linked to a particular location and/or a particular period of time. More specifically, a model linking carbon isotopic concentrations in ambient air to time period and location of air capture can be theoretically derived based on observed weather patterns (e.g., seasonal and geographic weather patterns). This model can then be leveraged to predict: a location (e.g., a latitude) of air capture for a particular diamond formed of the diamond composition 110 (e.g., given the time period and isotopic signature); a time period (a particular season) of air capture for this particular diamond (e.g., given the location and isotopic signature); and/or an isotopic signature of the particular diamond (e.g., given the location and time period).

For example, a first instance of the diamond composition 110 can be generated from an air sample—including carbon dioxide—captured at a first geographic location (e.g., at a first latitude) during a first period of time. The first instance of the diamond composition 110 can be configured to include: a first concentration of carbon-13 isotopes; and a second concentration of carbon-12 isotopes. The first concentration of carbon-13 and the second concentration of carbon-12 can define a first isotopic signature (e.g., a ratio of carbon-13 isotopes to carbon-12 isotopes) unique to the first instance of the diamond composition 110. Further, a second instance of the diamond composition 110 can be generated from a second air sample—including carbon dioxide—captured at a second geographic location (e.g., at a second latitude) during a second period of time. The second air sample can be ingested and processed to generate a second instance of the diamond composition 110 including: a third concentration of carbon-13 greater than the first concentration of carbon-13; and a fourth concentration of carbon-12 less than the second concentration of carbon-12. The third concentration of carbon-13 and the fourth concentration of carbon-12 can define a second isotopic signature unique to the second instance of the diamond composition 110.

In the preceding example, each instance of the diamond composition 110 can be traced to the original geographic location and/or time period during which the air sample was collected for generation of the diamond composition 110 based on the isotopic signature. For example, if the first and second instance of the diamond composition 110 include carbon sourced from an air sample collected during a particular time period: the first isotopic signature and the particular time period can be inserted into the model to identify the first geographic location; and the second isotopic signature and the particular time period can be inserted into the model to identify the second geographic location.

In another example, the diamond composition 110 can be generated via the method S100 and include carbon sourced from air captured at a target location. The diamond composition 110 can form a diamond defining a diamond identifier (e.g., serial number) engraved in the diamond and configured to associate the diamond with the target time period based on a model configured to predictably link the diamond identifier (e.g., serial number) to the target time period based on observed weather patterns.

In yet another example, the diamond composition 110 forms a diamond exhibiting a final ratio detectable via mass spectrometry and linked to a target location and a target time via a ratio database (e.g., database of ratios of carbon-13 isotopes to carbon-12 isotopes). The diamond composition 110 can be generated via the method S100 and includes a first amount of carbon-13 isotopes, a second amount of carbon-12 isotopes, and carbon sourced from a sample of air. The sample of air is collected at a target location and a target time during an air capture period and the final ratio of the first amount of carbon-13 isotopes to the second amount of carbon-12 isotopes is within a target range between −4.0 parts-per-thousand-versus-PDB-standard and −3.0 parts-per-thousand-versus-PDB-standard. The final ratio can then be linked to the target location and target time via a ratio database (e.g., database of ratios of carbon-13 isotopes to carbon-12 isotopes).

Therefore, a diamond owner wishing to identify a geographic location or time period of carbon capture for her diamond, formed of the diamond composition 110, may bring her diamond to any laboratory (e.g., analytical chemistry laboratory) for isotopic composition analysis of the diamond via mass spectrometry. Then, based on the isotopic composition (i.e., isotopic signature) of her diamond, the user may leverage: a known or approximate location of carbon collection to estimate a time period of carbon collection based on the model; or a known or approximate time period of carbon collection to estimate a geographic location of carbon collection for her diamond based on the model and/or ratio database. Similarly, a diamond owner (e.g., of a diamond formed of the diamond composition 110) may confirm a known location and known time period of carbon collection of a diamond by: completing isotopic composition analysis to identify a carbon isotopic signature of the diamond; and characterizing a “fit” between the known location, the known time period, and the carbon isotopic signature based on the model and/or ratio database.

### 6. Example

In the following examples, the diamond composition 110 was generated according to the method S100 and the isotopic ratio of carbon-13 to carbon-12 was measured.

In particular, for each example, an air sample (e.g., a volume of atmospheric air) was ingested to extract a volume of a first carbon dioxide mixture (e.g., a low-purity gaseous carbon dioxide mixture) from the air sample via amine filtration and/or additional heating techniques (e.g., to remove carbon dioxide from a filter). The first carbon dioxide mixture was then purified via liquefaction, within a set temperature range (e.g., less than 31 degrees Celsius) and a set pressure range (e.g., less than 73 bar), to remove impurities (e.g., nitrogen) from the first carbon dioxide mixture, thus generating a second carbon dioxide mixture (e.g., a liquid, high-purity carbon dioxide mixture) exhibiting a lower concentration of impurities than the first carbon dioxide mixture.

The second carbon dioxide mixture was then converted from a liquid state (e.g., after liquefaction) to a gaseous state via an expander. The second carbon dioxide mixture was then run through an absorption cartridge at a set flowrate (e.g., between 8 Liters/minute and 12 Liters/minute) to remove impurities (e.g., nitrogen oxides, ammonia) from the second carbon dioxide mixture.

The second carbon dioxide mixture was then mixed with a stream of hydrogen gas, in the presence of a catalyst, to generate a first hydrocarbon mixture, including methane, via methanation of the second carbon dioxide mixture in a methanation reactor. A stream of argon was also cycled through the methanation reactor to prevent introduction of impurities (e.g., nitrogen) into the methanation reactor.

The first hydrocarbon mixture was passed through a set of filters configured to collect impurities—such as compounds containing nitrogen (e.g., nitric oxide, nitrogen dioxide), hydrogen, carbon dioxide, argon, or other gases (e.g., other than methane)—present in the first hydrocarbon mixture, thereby generating a second hydrocarbon mixture exhibiting a lower concentration of impurities than the first hydrocarbon mixture. The second hydrocarbon mixture was then passed through a compressor to further reduce all non-hydrocarbon gases present in the second hydrocarbon mixture and a dryer to reduce moisture (e.g., water) present in the second hydrocarbon mixture.

The second hydrocarbon mixture was then deposited in a diamond reactor containing a set of diamond seeds to generate the diamond composition 110 via chemical vapor deposition. The diamond reactor was heated to temperatures within a set temperature range (e.g., greater than 800 degrees Celsius) to dispel carbon ions from the second hydrocarbon mixture and into the set of diamond seeds. The resulting set of diamonds—formed of the diamond composition 110—were collected and stored for further analysis.

### 6.1 Results

For each example, to analyze the carbon isotopic ratio of the diamond composition 110, a mass-to-charge ratio of both the carbon-12 isotope and the carbon-13 isotope were collected via isotope ratio mass spectrometry or (“IRMS”). The concentrations of each isotope were then estimated based on the measured mass-to-charge ratios for each isotope.

The carbon isotopic signature (i.e., 813C) of the diamond composition 110 was then estimated according to Equation 1 below.

$${δ}^{13} C = ( \frac{{( \frac{{}^{13} C}{{}^{12} C} )}_{sample}}{{( \frac{{}^{13} C}{{}^{12} C} )}_{standard}} — 1 ) \times 1000 \qquad ( EQUATION 1 )$$

The Pee Dee Belemnite (or “PDB”) reference was used as the standard such that the ratio of carbon-13 isotopes to carbon-12 isotopes for the standard was approximately 0.01123720.

In each example, each diamond tested includes: a first amount of carbon-13 isotopes; and a second amount of carbon-12 isotopes.

### 6.1.1 Example 1

In Example 1, as shown in FIG. 7, diamonds formed of the diamond composition 110 exhibited an average isotopic ratio (i.e., 813C) of the first amount of carbon-13 isotopes to the second amount of carbon-12 isotopes of −3.50 parts-per-thousand-versus-PDB-standard with a standard deviation of 0.015 parts-per-thousand-versus-PDB-standard.

As shown in FIG. 7, the synthetic CVD diamond exhibited an isotopic ratio (i.e., 813C) of the first amount of carbon-13 isotopes to the second amount of carbon-12 isotopes of −52.445 parts-per-thousand-versus-PDB-standard with a standard deviation of 0.015 parts-per-thousand-versus-PDB-standard. The synthetic HPHT diamond exhibited an isotopic ratio (i.e., 813C) of the first amount of carbon-13 isotopes to the second amount of carbon-12 isotopes of −19.709 parts-per-thousand-versus-PDB-standard with a standard deviation of 0.008 parts-per-thousand-versus-PDB-standard.

As shown in FIG. 7, approximately 95 percent of Peridotitic diamonds (i.e., natural diamonds, ground-sourced diamonds), including silicate inclusions, exhibited an isotopic ratio (i.e., 813C) of the first amount of carbon-13 isotopes to the second amount of carbon-12 isotopes between 2.0 parts-per-thousand-versus-PDB-standard and 8.0 parts-per-thousand-versus-PDB-standard. Further, approximately 75 percent of Eclogitic diamonds (i.e., natural diamonds, ground-sourced diamonds), including silicate inclusions, exhibited an isotopic ratio (i.e., 813C) of the first amount of carbon-13 isotopes to the second amount of carbon-12 isotopes between −2.0 parts-per-thousand-versus-PDB-standard and −8.0 parts-per-thousand-versus-PDB-standard.

As shown in FIG. 7, the natural diamonds—Peridotitic and Eclogitic—define a target isotopic signature range between 2.0 parts-per-thousand-versus-PDB-standard and −8.0 parts-per-thousand-versus-PDB-standard. The diamond composition 110 exhibits a carbon isotopic signature within this target isotopic signature range. Further, the diamond composition 110 exhibits a carbon isotopic signature that is less depleted (or more enriched) in carbon-13 isotopes than the HPHT and CVD diamonds. The HPHT diamonds exhibit a carbon isotopic signature outside of the target isotopic signature range and are more depleted in carbon-13 than the diamond composition 110. The CVD diamonds also exhibit a carbon isotopic signature outside of the target isotopic signature range and are more depleted in carbon-13 than both the diamond composition 110 and the HPHT diamonds.

Therefore, while the lab-grown HPHT and CVD diamonds may be detectably distinct from natural, ground-sourced diamonds (e.g., Eclogitic and/or Peridotitic diamonds), the diamond composition 110 is not detectably (e.g., via mass spectroscopy) distinct from the natural, ground-sourced diamonds (e.g., based on the corresponding carbon isotopic signatures).

### 6.1.2 Example 2

In Example 2, as shown in FIG. 8, diamonds formed of the diamond composition 110 exhibited an average isotopic ratio (i.e., 813C) of the first amount of carbon-13 isotopes to the second amount of carbon-12 isotopes of −3.50 parts-per-thousand-versus-PDB-standard with a standard deviation of 0.015 parts-per-thousand-versus-PDB-standard.

As shown in FIG. 8, the synthetic CVD diamond exhibited an isotopic ratio (i.e., 813C) of the first amount of carbon-13 isotopes to the second amount of carbon-12 isotopes of −52.2 parts-per-thousand-versus-PDB-standard with a standard deviation of 0.015 parts-per-thousand-versus-PDB-standard. The synthetic HPHT diamond exhibited an isotopic ratio (i.e., 813C) of the first amount of carbon-13 isotopes to the second amount of carbon-12 isotopes of −17.4 parts-per-thousand-versus-PDB-standard with a standard deviation of 0.008 parts-per-thousand-versus-PDB-standard.

Therefore, while the lab-grown HPHT and CVD diamonds may be detectably distinct from natural, ground-sourced diamonds (e.g., Eclogitic and/or Peridotitic diamonds), the diamond composition 110 is not detectably (e.g., via mass spectroscopy) distinct from the natural, ground-sourced diamonds based on the corresponding carbon isotopic signatures.

However, in one variation, as described above, the diamond composition 110 can be configured to exhibit an isotopic signature—defining a ratio (or “isotopic ratio”) of carbon-13 isotopes to carbon-12 isotopes—outside of a target isotopic signature range (e.g., between 2.0 parts-per-thousand-versus-PDB-standard and −8.0 parts-per-thousand-versus-PDB-standard) defined by the natural diamonds by conveying the upstream carbon dioxide mixture through a distillation column configured to regulate the carbon isotopic signature of the carbon dioxide mixture.

### 7. Certification of Diamonds+Intermediate Products+Diamond Products

As described above, diamonds generated from carbon derived from air can be configured to exhibit a carbon isotopic signature distinct from both: traditional lab-grown diamonds generated from materials including carbon sourced from the ground, such as via HP-HT or CVD; and/or natural diamonds mined directly from the ground (or “mined” diamonds).

Therefore, in one variation, these carbon isotopic signatures can be leveraged to distinguish a diamond generated from carbon sourced from air such as formed of the diamond composition 110—from a traditional lab-grown diamond including ground-sourced carbon and/or from a natural diamond (e.g., a ground-sourced or “mined” diamond). In particular, a carbon isotopic signature—defining carbon isotopic concentrations (e.g., of Carbon-13 and/or Carbon-12)—can be derived for a particular diamond via execution of a standard carbon-13 test, such as via implementation of mass spectroscopy techniques. This standard carbon-13 test can therefore be executed to: derive a carbon isotopic signature for a particular diamond via mass spectroscopy; predict a source of carbon included in this particular diamond based on the carbon isotopic signature; and thus certify (e.g., verify, quality check) this particular diamond as derived from carbon sourced from air—such as a diamond formed of the diamond composition 110—or from the ground (e.g., a mined diamond, a traditional lab-grown diamond).

In one example, an “air” diamond (i.e., a diamond including carbon derived from air) can be defined as a diamond exhibiting a ratio of carbon-13 isotopes to carbon-12 isotopes between −10.0 parts-per-thousand-versus-PDB-standard and 1.0 parts-per-thousand-versus-PDB-standard. Therefore, a diamond defining a ratio of carbon-13 isotopes to carbon-12 isotopes—defining the carbon isotopic signature of the diamond—falling within this target range can be certified as an “air” diamond and therefore distinguished from diamonds generated from carbon sourced from the ground. Additionally and/or alternatively, in other examples, an “air” diamond can be defined as a diamond exhibiting a ratio of carbon-13 isotopes to carbon-12 isotopes: between −3.610 parts-per-thousand-versus-PDB-standard and −3.590 parts-per-thousand-versus-PDB-standard; between −4.0 parts-per-thousand-versus-PDB-standard and −3.0 parts-per-thousand-versus-PDB-standard; greater than −5.0 parts-per-thousand-versus-PDB-standard; greater than −10.0 parts-per-thousand-versus-PDB-standard; etc.

In one implementation, Blocks of the method S100 can be executed by a system—such as a computer system configured to interface with a testing facility (e.g., an automated testing facility) and/or a human operator—to: confirm identity of a diamond or group of diamonds received at the testing facility; trigger execution of the standard carbon-13 test for this diamond or a representative diamond(s) in the group of diamonds; derive a carbon isotopic signature of the diamond based on results of the standard carbon-13 test; and certify the diamond or group of diamonds as derived from carbon sourced from air based on the carbon isotopic signature falling within a target range defined for diamonds derived from carbon sourced from air (or “air-sourced carbon”). Further, the system can similarly certify a raw diamond, an intermediate product (e.g., methane, carbon dioxide), and/or a final diamond product as derived from carbon sourced from air.

For example, during execution of the carbon-13 test: a test sample (e.g., a small portion of the diamond) can be extracted from the diamond (e.g., via laser ablation); the test sample can be heated in a chamber to generate a carbon dioxide mixture; and a concentration of carbon-13 isotopes present in the carbon dioxide mixture within the chamber can be measured (e.g., via a cyclotron).

In one example, the system can: confirm receipt of a diamond at the diamond facility, such as via scanning of a unique identifier engraved in the diamond and/or arranged on a container containing the diamond; trigger execution of the carbon-13 test, such as via transmitting a command to the automated testing facility configured to execute the carbon-13 test or prompting an operator to manually execute the carbon-13 test for this particular diamond; access a set of isotopic data (e.g., recorded by a mass spectrometer or other testing instruments, manually uploaded by the operator) derived from execution of the carbon-13 test; derive a carbon isotopic signature for the diamond based on the set of isotopic data; link the carbon isotopic signature to the unique identifier assigned to the diamond; selectively certify the diamond as derived from carbon sourced from air or from the ground based on the carbon isotopic signature; and link this certification to the diamond identifier in combination with the carbon isotopic signature, such as in a diamond profile—stored within a diamond concentration database—generated for this particular diamond.

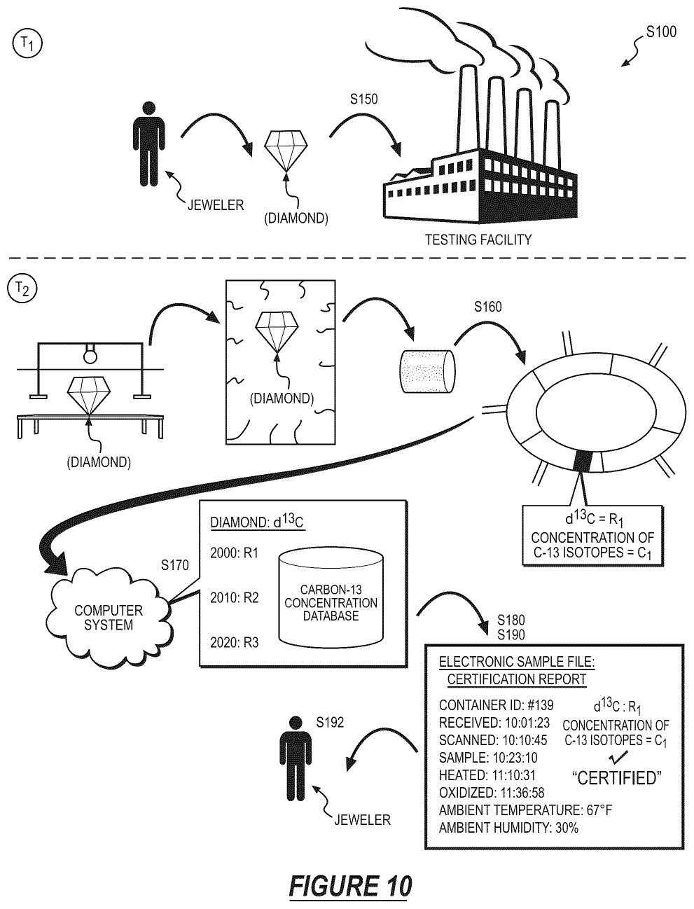

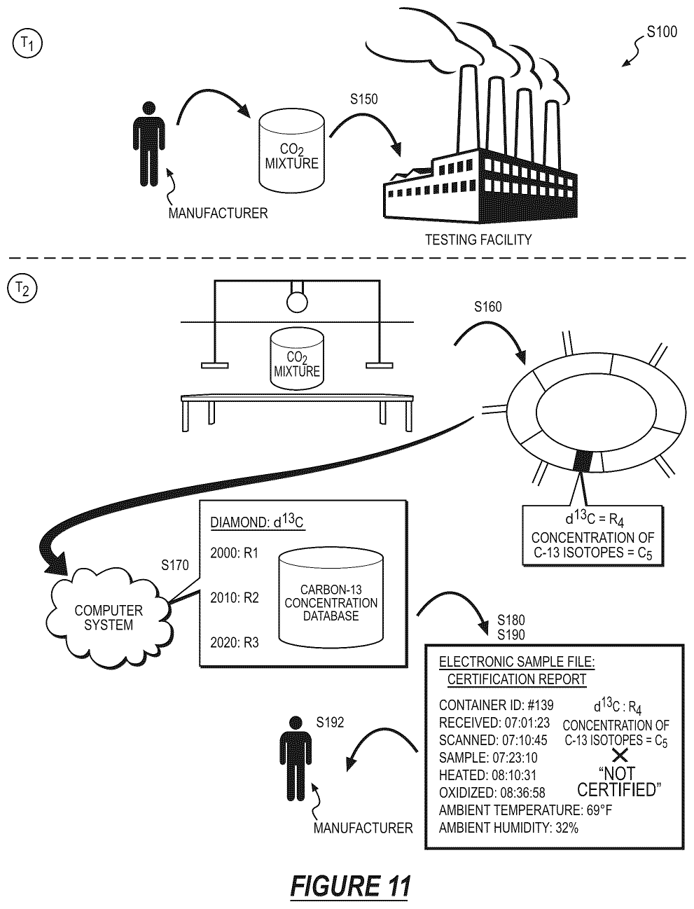

In this variation, as shown in FIGS. 10 and 11, Blocks of the method S100 can include: confirming receipt of a first diamond at a testing facility at a first time in Block S150; accessing a first set of isotopic data derived for the first diamond via execution of a first carbon test during a first test period succeeding the first time in Block S160; deriving a carbon isotopic signature—defining a first concentration of carbon-13 isotopes—for the first diamond based on the first set of isotopic data in Block S170; accessing a baseline concentration of carbon-13 isotopes defined for a representative diamond including carbon sourced from air; characterize a first difference between the first concentration and the baseline concentration in Block S172; in response to the first difference falling below a threshold difference, certifying the first diamond as an “air” diamond including carbon sourced from air in Block S180; and, in response to the first difference exceeding the threshold difference, withholding certification of the first diamond as an “air” diamond in Block S180. Blocks of the method S100 can further include: generating a report including the first concentration of carbon-13 isotopes and indicating certification of the first diamond as an “air” diamond in Block S190; and transmitting the report to a user affiliated with the first diamond in Block S192.

Additionally or alternatively, the system can similarly test physical properties (e.g., weight, hardness, melting point, strength, electrical conductivity, thermal conductivity) of a raw diamond, an intermediate product (e.g., methane, carbon dioxide), and/or a final diamond product (e.g., an electronic device, a semiconductor). The system can then certify the raw diamond, intermediate product, and/or final diamond product as derived from carbon sourced from air based on these properties.

In one variation, a raw diamond, intermediate product, and/or final diamond product can exhibit a weight proportional to the concentration of carbon-13 isotopes present in a sample of the raw diamond, intermediate product, and/or final diamond product. In this variation, the system can: characterize a first weight of a first diamond; access a baseline weight corresponding to a baseline concentration of carbon-13 isotopes for a representative diamond including carbon sourced from air; characterize a first difference between the first weight and the baseline weight; and, in response to the first difference falling below a threshold difference, certify the first diamond as an “air” diamond including carbon sourced from air in Block S180.

### 7.1 Examples

In one example, a jeweler or diamond seller in possession of a group (or “constellation”) of diamonds—generated and/or allegedly generated from carbon sourced from air—may want to verify this constellation of diamonds as derived from carbon sourced from air, such as in order to advertise these diamonds as certified “air” diamonds (i.e., diamonds derived from carbon sourced from air). The jeweler may therefore send the constellation of diamonds—or a representative diamond or subset of diamonds in the constellation—to a testing facility in order to certify (e.g., verify, quality check) each diamond in the constellation of diamonds. Then, for each diamond in the constellation of diamonds—or for the representative diamond or subset of diamonds—a carbon test can be executed to derive a carbon isotopic signature representative of diamonds in the constellation of diamonds. In response to the carbon isotopic signature falling within a target carbon isotopic signature range defined for certified “air” diamonds, the constellation of diamonds can be certified as “air” diamonds. This carbon isotopic signature and corresponding certification can then be reported to the jeweler.

For example, the jeweler can initially deliver or send (e.g., ship) a constellation of diamonds to the test facility for verification. Upon completion of the carbon test, the system can: access a set of isotopic data collected during execution of the carbon test; derive a carbon isotopic signature—or an average carbon isotopic signature—of diamonds in the constellation of diamonds based on the set of isotopic data; and link the carbon isotopic signature to this constellation of diamonds, such as via linking of a diamond identifier (e.g., engraved on the diamond, arranged on a diamond container) associated with the constellation of diamonds to the carbon isotopic signature within an electronic sample file or profile generated for this constellation of diamonds. Then, in response to the carbon isotopic signature specifying a concentration of carbon-13 isotopes between −20 parts-per-thousand-versus-PDB-standard and 5.0 parts-per-thousand-versus-PDB-standard, certify the constellation of diamonds as “air” diamonds. Alternatively, in response to the carbon isotopic signature specifying a concentration of carbon-13 isotopes less than −20 parts-per-thousand-versus-PDB-standard, the system can deny certification as “air” diamonds and rather predict that the constellation of diamonds include ground-sourced carbon. Based on these results, the system can: generate a report (e.g., a record, an electronic sample file) indicating certification and/or denial of certification of the constellation of diamonds as “air” diamonds; transmit the report to the jeweler; and/or upload the report to a database (e.g., a searchable, online database) including a corpus of historical reports generated for diamonds certified and/or denied certification.

Additionally and/or alternatively, in the preceding example, in response to certifying the constellation of diamonds as “air” diamonds, each diamond in the constellation can be engraved with an indicator (e.g., a set of characters, a QR code, a symbol) indicating certification of the diamond as an “air” diamond. For example, a diamond purchaser—purchasing the diamond from the jeweler—may scan a QR code engraved in the diamond to access the report specifying the carbon isotopic signature and indicating certification of the diamond as an “air” diamond.

In another example, a couple may purchase an engagement ring including a particular diamond generated from carbon sourced from air. The couple may want to verify that this particular diamond—set in the engagement ring—is derived from carbon sourced from air. Accordingly, the couple may deliver the engagement ring to a test facility—such as a test facility within a laboratory site or deployed to a local jeweler—for verification of the diamond. At the test facility, the system can: receive (e.g., via scanning) and/or assign a unique identifier (e.g., serial number, SKU) to the diamond; generate an electronic sample file for this diamond and link the unique identifier to this electronic sample file; confirm execution of the carbon test for this diamond; access a set of isotopic data recorded during execution of the carbon test for this diamond and derive a carbon isotopic signature for the diamond accordingly; and upload the carbon isotopic signature and/or the set of isotopic data to the electronic sample file to link this data to the unique identifier. The system can then: generate a report (e.g., certificate) indicating certification or denial of certification of the diamond as an “air” diamond; and upload this report to the electronic sample file. Further, a copy (e.g., a printed copy, an electronic copy) of this report can be delivered to the couple.

In yet another example, a manufacturer associated with a manufacturing facility of diamonds and/or final diamond products (e.g., semiconductors, fuel, plastic, carbon fiber) may want to certify an intermediate product—such as carbon dioxide, methane, etc.—as carbon sourced from air prior to transformation of the intermediate product into a diamond and/or final diamond product. In particular, the intermediate product can be sent to the manufacturing facility for generation of diamonds and/or final diamond products from the intermediate product.

However, in the preceding example, prior to generation of the diamond and/or final diamond product from the intermediate product, the manufacturer associated with the manufacturing facility may send the intermediate product—such as a volume of this intermediate product stored in a storage vessel—to a testing facility for execution of the carbon test. For example, the manufacturer may send a volume of methane—including carbon sourced from air—to the testing facility for execution of the carbon test. In this example, the volume of methane can be shipped in a storage vessel including an identifier arranged on a surface of the storage vessel. Upon receiving the storage vessel at the test facility, the system can link the identifier arranged on the storage vessel to the volume of methane and to results of the carbon test. The system can similarly generate a report indicating certification and/or denial of certification of the volume of methane as “gas-captured” methane (i.e., methane including carbon sourced from air), transmit this report to the manufacturer, and/or upload this report to a database.

Therefore, a seller, purchaser, manufacturer, etc. of a diamond and/or final diamond product may send the diamond and/or final diamond product to a testing facility for certification and/or verification as an “air” diamond (i.e., a diamond derived from carbon sourced from air). A manufacturer may also send intermediate products (e.g., carbon dioxide mixture, methane mixture) to the testing facility for certification as carbon sourced from air prior to generation of a set of diamonds and/or final diamond products.

### 7.2 Certification Process

In one implementation, a diamond, a final diamond product, and/or an intermediate product (e.g., carbon dioxide mixture, methane mixture) can be sent to a testing facility for certification by a user (e.g., diamond purchaser, manufacturer, jeweler). The system can then certify the diamond, final diamond product, and/or intermediate product via a certification process.

In one variation, the system can assign a unique identifier to a diamond to track the diamond during each segment of the certification process. A sample of the diamond can be collected by removing the sample from the diamond—such as a microdot test—via laser ablation. The sample can then be heated, in a chamber, to generate a carbon dioxide mixture including a first concentration of carbon dioxide. The carbon dioxide mixture can then be oxidized, in a cyclotron, and the concentration of carbon-13 isotopes within the carbon dioxide mixture can be measured by the cyclotron via mass spectrometry. The system can then access a concentration database of carbon-13 isotopes and select a corresponding known “air” diamond—defining a target concentration of carbon-13 isotopes corresponding to diamonds derived from carbon sourced from air—from the database to selectively certify the diamond as derived from carbon sourced from air.

Furthermore, a computer system can update the unique identifier associated with the diamond or assign a second unique identifier (e.g., check mark, etching, symbol) to the diamond to indicate certification as derived from carbon sourced from air. The computer system can also transmit a certification report including data—such as concentrations of carbon-13 isotopes and carbon-12 isotopes, timestamps for each segment of the certification process, environmental data within the testing facility etc.—collected during execution of the certification process to a computing device accessible by a user (e.g., diamond purchaser, manufacturer, jeweler) associated with the diamond.

In another variation, the system can receive a container including a batch of an intermediate product (e.g., carbon dioxide mixture, methane) from a manufacturer exhibiting a first concentration of carbon dioxide. The system can assign a unique identifier to the container to track the batch of the intermediate product during each segment of the certification process. The batch of the intermediate product can then be oxidized, in the cyclotron, and the concentration of carbon-13 isotopes within the batch of the intermediate product can be measured by the cyclotron via mass spectrometry. The system can then access the concentration database of carbon-13 isotopes and select a corresponding known intermediate product from the database to certify the batch of the intermediate product as derived from carbon sourced from air.

Additionally, the computer system can update the unique identifier on the container and transmit a certification report including data—such as concentrations of carbon-13 isotopes and carbon-12 isotopes, timestamps for each segment of the certification process, environmental data within the testing facility etc.—collected during the certification process of the batch of the intermediate product to a computing device accessible by the manufacturer associated with the batch of the intermediate product. The manufacturer can then generate diamonds and/or final diamond products from the batch of intermediate products and assign a second unique identifier (e.g., check mark, etching, symbol) to the diamond and/or final diamond product to indicate certification of the diamond and/or final diamond product as derived from carbon sourced from air.

Thus, the system can execute Blocks of the method S100 to certify a diamond, intermediate product and/or a final diamond product as derived from carbon sourced from air at the testing facility and thereby enable a user (e.g., jeweler, manufacturer) to mark the diamond, intermediate product, and/or final diamond product as a certified “air” diamond prior to sale to a purchaser (e.g., consumer).

### 7.2.1 Historical Record: Concentration Database

In one implementation, during a particular time period (e.g., one week, one month, one year), the system can generate and store an historical record of the concentration of carbon-13 isotopes associated with a diamond, an intermediate product (e.g., carbon dioxide mixture, hydrocarbon mixture, methane mixture), and/or a final diamond product (e.g., set diamond piece, jewelry, fuel, plastic, carbon fiber) in a concentration database of carbon-13 isotopes.

For example, during a particular time period (e.g., one month), the system can: receive a final diamond product from a particular source (e.g., jeweler, manufacturer); implement the methods and techniques described above to certify the final diamond product; extract the concentration of carbon-13 isotopes from a sample of the final diamond product; and store the concentration of carbon-13 isotopes associated with this final diamond product in a database. The system can repeat these methods and techniques for each other final diamond product, each other diamond, and each other intermediate product to generate a robust concentration database of carbon-13 isotopes.

Furthermore, the system can receive a next diamond product, test a sample of the next final diamond product and compare the concentration of carbon-13 isotopes to a corresponding diamond product in the concentration database of carbon-13 isotopes, and generate a notification indicating the next final diamond product as certified or not certified as further described below.

In another implementation, the system can receive a corresponding pair of diamonds, intermediate products (e.g., carbon dioxide mixtures, hydrocarbon mixtures, methane mixtures), and/or final diamond products (e.g., fuels, plastics, carbon fibers) from a user. In particular, the pair can include a first diamond derived from carbon sourced from air and a second diamond derived from carbon not sourced from air (e.g., ground-sourced diamond, CVD diamond). The system can then store a concentration of carbon-13 isotopes for the second diamond to generate a concentration database of carbon-13 isotopes.

For example, the system can: receive a first diamond derived from carbon sourced from air and a second diamond derived from carbon sourced from the ground; execute a first carbon test for the first diamond to identify a first concentration of carbon-13 isotopes present in the first diamond; execute a second carbon test for the second diamond to identify a second concentration of carbon-13 isotopes present in the second diamond; store the second concentration of carbon-13 isotopes from the second diamond in a concentration database of carbon-13 isotopes; label the second concentration of carbon-13 isotopes for the second diamond as corresponding to a ground-sourced diamond; and compare the first concentration of carbon-13 isotopes from the first diamond to the second concentration of carbon-13 isotopes from the second diamond to certify the first diamond as derived from carbon sourced from air. The system can repeat these methods and techniques for each other pair to generate a robust concentration database of carbon-13 isotopes.

A user (e.g., manufacturer, diamond purchaser, jeweler) may provide a pair of diamonds for certification. However, the user may also provide a first diamond product and/or intermediate product to the testing facility for certification as derived from carbon sourced from air and a second corresponding diamond product, and/or intermediate product not derived from carbon sourced from air as a baseline to the testing facility.

### 7.2.2 Certification Metrics: Concentration of Carbon-13 Isotopes+Indicator

In one implementation, after generation of the concentration database of carbon-13 isotopes, the system can access a concentration of carbon-13 isotopes derived for a particular diamond, an intermediate product, and/or a final diamond product, and compare the concentration to a baseline concentration of carbon-13 isotopes for a corresponding diamond, intermediate product, and/or final diamond product from the concentration database of carbon-13 isotopes. The system can then: selectively certify the diamond, intermediate product, and/or final diamond product; and transmit an indicator representing certification and the extracted concentration of carbon-13 isotopes for the diamond, intermediate product, and/or final diamond product.

For example, upon completion of the carbon test for a diamond, the system can: access a concentration of carbon-13 isotopes derived for the diamond; access a baseline concentrations of carbon-13 isotopes defined for a representative “air” diamond, such as an average concentration of carbon-13 isotopes present in diamonds derived from carbon sourced from air; characterize a difference between the concentration of carbon-13 isotopes in the diamond and the baseline concentration; and, in response to the difference falling within a threshold difference, certify the diamond as an “air” diamond. The system can then: generate a report (e.g., an electronic sample file)—including the indicator representing certification of the diamond as an “air” diamond—for the diamond; and transmit the report to a user affiliated with the diamond. Additionally, in this example, the system can update the concentration database of carbon-13 isotopes based on the diamond and the corresponding concentration of carbon-13 isotopes.

In one variation, the computer system can generate the indicator representing the concentration of carbon-13 isotopes in parts-per-thousand-versus-PDB-standard. In another variation, the computer system can generate the indicator representing the concentration of carbon-13 isotopes as a percentage of carbon-13 isotopes per composition (e.g., 75% carbon-13 isotopes, 90% carbon-13 isotopes) of the diamond, intermediate product, and/or final diamond product. In yet another variation, the computer system can generate the indicator representing the concentration of carbon-13 isotopes as a numerical metric of carbon-13 isotopes (e.g., level 5=99% carbon-13 isotopes, level 4=95% carbon-13 isotopes, level 3=90% carbon-13 isotopes isotopes). In yet another variation, the computer system can generate the indicator representing the concentration of carbon-13 isotopes as a symbol (e.g., star, check mark, geometric shape) and mark the diamond, intermediate product, and/or final product with the symbol.

For example, the system can receive a set of (e.g., three) diamonds from a jeweler and the system can implement the methods and techniques described above to certify the set of (e.g., three) diamonds. The system can then extract a first concentration of carbon-13 isotopes from a first diamond, a second concentration of carbon-13 isotopes from a second diamond, and a third concentration of carbon-13 isotopes from a third diamond. The computer system can then access the concentration database of carbon-13 isotopes to select a corresponding known diamond as a baseline concentration of carbon-13 isotopes. The computer system can then calculate a first difference between the first concentration of carbon-13 isotopes of the first diamond and the baseline concentration of carbon-13 isotopes. In response to the first difference falling within a target difference range, the computer system can certify the first diamond as derived from carbon sourced from air and generate a first indicator representing the first concentration of carbon-13 isotopes as level 5 (e.g., level 5=99% carbon-13 isotopes). The computer system can then calculate a second difference between the second concentration of carbon-13 isotopes of the second diamond and the baseline concentration of carbon-13 isotopes. In response to the second difference falling within the target difference range, the computer system can certify the second diamond as derived from carbon sourced from air and generate a second indicator representing the second concentration of carbon-13 isotopes as level 3 (e.g., level 3=90% carbon-13 isotopes). The computer system can then calculate a third difference between the second concentration of carbon-13 isotopes of the third diamond and the baseline concentration of carbon-13 isotopes. In response to the third difference falling within the target difference range, the computer system can certify the third diamond as derived from carbon sourced from air and generate a third indicator representing the third concentration of carbon-13 isotopes as level 4 (e.g., level 4=95% carbon-13 isotopes).

Thus, the jeweler can receive the set of (e.g., three) diamonds, each diamond marked with an indicator representing the concentration of carbon-13 isotopes in the diamond with a numerical metric (e.g., level 5=99% carbon-13 isotopes, level 3=90% carbon-13 isotopes, level 4=95% carbon-13 isotopes).

### 7.3 Example: Jeweler+Constellation of Diamonds

In this example, a group (or “constellation”) of diamonds can be generated from carbon sourced from air and a jeweler in possession of the constellation of diamonds may want to send the constellation of diamonds to a testing facility to certify (e.g., verify, quality check) that each diamond in the constellation of diamonds is derived from carbon sourced from air. Then for each diamond in the constellation of diamonds, the system can: test the diamond; generate an indicator representing the concentration of carbon-13 isotopes to certify the diamond (e.g., derived from carbon sourced from air) or not certify the diamond (e.g., not derived from carbon sourced from air); and present a report of data (e.g., list, record, electronic sample file of data) associated with the diamond to the jeweler for review.

In particular, upon arrival of the constellation of diamonds at the testing facility, the system can assign an unique identifier (e.g., QR code, barcode) to each diamond in the constellation of diamonds and the identifier can be scanned prior to each segment of the certification process to track each diamond. Then, for a first diamond in the constellation of diamonds, a sample of the first diamond can be collected by removing the sample from the diamond—such as a microdot test—via laser ablation. The sample can then be heated, in a chamber, to generate a carbon dioxide mixture including a first concentration of carbon dioxide. The carbon dioxide mixture can then be oxidized, in a cyclotron, and the concentration of carbon-13 isotopes within the carbon dioxide mixture can be measured by the cyclotron via mass spectrometry. The computer system can then access the concentration database of carbon-13 isotopes and select a corresponding known diamond from the concentration database of carbon-13 isotopes. The computer system can calculate a difference between the concentration of carbon-13 isotopes of the first diamond and the corresponding known diamond. Then, in response to the difference falling within a target difference range, the computer system can generate an indicator (e.g., a check mark) representing the concentration of carbon-13 isotopes and mark the first diamond with the indicator (e.g., check mark) to certify the first diamond. The computer system can also generate a report of the data extracted from the sample of the first diamond and transmit this report of data for the first diamond to a computing device accessible by the jeweler for review. Alternatively, in response to the difference falling outside of the target difference range, the computer system can generate an indicator (e.g., 50%) representing the concentration of carbon-13 isotopes and generate a notification alerting the jeweler that the first diamond is not certified as derived from carbon sourced from air. The computer system can repeat these methods and techniques for each other diamond in the constellation of diamonds to certify the constellation of diamonds as derived from carbon sourced from air.

### 7.4 Variation: Certification of Non-Diamond Products

In one variation, a product containing carbon (e.g., gasoline, apparel, plastic, furniture, alcohol, cutlery, accessories) can be sent to the testing facility for certification and/or verification as including carbon sourced from air.

In one implementation, a manufacturer or supplier may want to certify a product as including carbon sourced from air. In this implementation, the supplier may ship a batch, volume, or representative unit of a product to the testing facility for execution of the carbon-13 test. Alternatively, the carbon-13 test can be executed directly within a manufacturing facility associated with the supplier. The carbon-13 test can then be executed to: verify a source of carbon included in the product; and/or selectively certify the product as derived from carbon sourced from air based on the carbon isotopic signature of the product. For example, the carbon-13 test can be executed to derive a carbon isotopic signature for a volume of gasoline, a plant-based food product, a fabric or clothing product, etc.

In another implementation, a retailer may want to advertise a product containing carbon (e.g., a bar of soap) as manufactured by “clean” or “green” practices, such as extracting carbon dioxide from air and converting the carbon dioxide into the product containing carbon. The retailer may send the product to the testing facility for certification as derived from carbon sourced from air. If the product is certified as carbon sourced from air, the retailer may then mark the product with an indicator (e.g., label, symbol, checkmark) demonstrating certification of the product to an end user (e.g., purchaser, consumer) who may want to purchase products containing carbon sourced from air.

For example, a retailer may want to certify that a bar of soap is derived from carbon sourced from air. In this example, the retailer may send the bar of soap to the testing facility. Upon receipt of the bar of soap, the system can scan the bar of soap and assign a unique identifier to track the bar of soap during each segment of the certification process. A sample of the bar of soap can be collected and then heated, in a chamber, to generate a carbon dioxide mixture including a first concentration of carbon dioxide. The carbon dioxide mixture can then be oxidized, in a cyclotron, and the concentration of carbon-13 isotopes and/or the isotopic signature (e.g., ration of carbon-13 isotopes to carbon-12 isotopes) within the carbon dioxide mixture can be measured by the cyclotron via mass spectrometry. The system can then access a concentration database of carbon-13 isotopes and select a corresponding known carbon product (e.g., bar of soap) from the database to certify the bar of soap as derived from carbon sourced from air.

Therefore, the system can certify products containing carbon as derived from carbon sourced from air and thus enable a retailer and/or end user to verify a product containing carbon as derived from carbon sourced from air.

### 8. Applications: Solid Carbon Products

Blocks of the method S100 can be executed to generate a carbon composition 100 including carbon sourced from a volume of captured gas, such from a volume of a point source (e.g., a flue gas) and/or a volume of atmospheric air. Generally, the carbon composition 100 is an ethically-sourced, carbon-negative, solid carbon product. In particular, the method S100 can be executed to: capture a gaseous mixture of carbon dioxide and/or other components found in air (e.g., nitrogen, argon) and/or a flue stack—via point-source capture and/or direct air capture—from a volume of gas (e.g., re-circulated air within a building, outdoor air, air pollution, human breath, a flue stack); to process this gaseous mixture of carbon dioxide and other components—according to various chemical techniques and/or in combination with additional components—to form a hydrocarbon mixture; and to further react this hydrocarbon mixture to form the carbon composition 100 (e.g., graphite, graphene, carbon black, carbon nanotubes). By implementing point-source and/or direct air capture of a gaseous carbon dioxide mixture from a volume of gas (e.g., atmospheric air, flue gas) and transforming this mixture into a hydrocarbon precursor (i.e., the hydrocarbon mixture) for production of the carbon composition 100, the method S100 enables elimination of pollution, greenhouse gases, and mineral and water waste generated due to sourcing hydrocarbons (e.g., fossil fuels) directly from the ground via mining.

Further, carbon products formed of the carbon composition 100—such as graphene, graphite, carbon black, carbon nanotubes, diamond, etc.—include carbon isotopic concentrations differing from counterpart carbon products including carbon sourced from the ground.

In particular, the carbon composition 100 defines a particular carbon isotopic signature (e.g., a ratio of carbon-13 isotopes to carbon-12 isotopes present in the diamond composition 110) within a particular range different from counterpart carbon composition 100s formed from carbon sourced from the ground (or “ground-sourced carbon”). Therefore, by sourcing carbon from the air—rather than the ground—the carbon composition 100 is less depleted in carbon-13 isotopes than traditional carbon materials formed of ground-sourced carbon, which may be more heavily depleted in carbon-13.

This carbon isotopic signature can be leveraged to distinguish ground-sourced carbon materials from the carbon composition 100 by measuring carbon isotopic concentrations of these carbon materials via mass spectroscopy in a standard carbon-13 test. For example, carbon materials—such as including carbon black, graphite, graphene, carbon nanotubes, etc.—formed of carbon sourced from the ground can exhibit carbon isotopic signatures less than −50 parts-per-thousand-versus-PDB-standard. Alternatively, the carbon composition 100—including carbon sourced from a volume of above-ground gases (e.g., air, flue gas)—can exhibit carbon isotopic signatures exceeding −50 parts-per-thousand-versus-PDB-standard, such as within a target range between −50 parts-per-thousand-versus-PDB-standard and zero parts-per-thousand-versus-PDB-standard. These counterpart carbon materials—formed of carbon sourced from the ground—are therefore readily detectable as including ground-sourced carbon. However, by sourcing carbon from atmospheric air and/or a point source—which is more enriched in carbon-13 isotopes—the carbon composition 100 can exhibit a carbon isotopic signature within this target range.

In one implementation, Blocks of the method S100 include: ingesting a carbon dioxide mixture—including carbon dioxide and a first concentration of impurities (e.g., nitrogen) extracted from an air sample (e.g., a point source, atmospheric air); conveying the carbon dioxide mixture through a pressurized unit at temperatures within a first temperature range to promote liquefaction of the carbon dioxide mixture to generate a first exhaust stream including impurities (e.g., nitrogen) and a second carbon dioxide mixture including carbon dioxide and a second concentration of impurities less than the first concentration of impurities; in a methanation reactor, mixing the second carbon dioxide mixture with a stream of hydrogen to generate a first hydrocarbon mixture including hydrocarbons (e.g., methane) and a third concentration of impurities (e.g., nitrogen, carbon dioxide, and hydrogen); conveying the first hydrocarbon mixture through a separation unit configured to remove impurities from the first hydrocarbon mixture to generate a second hydrocarbon mixture including hydrocarbons (e.g., methane) and a fourth concentration of impurities less than the third concentration of impurities; and, depositing the second hydrocarbon mixture in a reactor and exposing the second hydrocarbon mixture to a set of conditions (e.g., temperature) configured to promote generation of a carbon composition 100.

### 8.1 Air Capture

Generally, a carbon dioxide mixture—including carbon dioxide and/or impurities (e.g., nitrogen, argon) present in air—can be extracted from a volume of gas. For example, the carbon dioxide mixture can be captured via point-source capture and/or via direct air capture. The carbon dioxide mixture can then be further processed to exhibit a target concentration—exceeding a threshold concentration (e.g., 95 percent, 99 percent)—of carbon dioxide.

In particular, in one example, the carbon dioxide mixture can: be extracted from a volume of gas (e.g., flue gas, atmospheric air) via point source capture and/or direct air capture; and define a first concentration of carbon dioxide. Then, the carbon dioxide mixture can: be conveyed through a pressurized unit (e.g., a liquefaction unit) at temperatures within a first temperature range to promote liquefaction of the carbon dioxide mixture to remove impurities from the carbon dioxide mixture; and—at an outlet of the pressurized unit—define a second concentration of carbon dioxide exceeding the first concentration.

In one implementation, the carbon dioxide mixture includes carbon including a ratio of a first amount of carbon-13 isotopes and a second amount of carbon-12 isotopes. The carbon dioxide mixture can define a ratio of the first amount of carbon-13 isotopes to the second amount of carbon-12 isotopes exceeding −45.0 parts-per-thousand-versus-PDB-standard. Alternatively, carbon dioxide sourced from the ground—rather than sourced from an above-ground gas (e.g., via point source and/or direct air capture)—may exhibit an average ratio of carbon-13 isotopes to carbon-12 isotopes less than −45.0 parts-per-thousand-versus-PDB-standard, such as within a threshold deviation of −50 parts-per-thousand-versus-PDB-standard.

Therefore, by capturing the carbon dioxide mixture from gases captured above-ground—rather than from the ground—the carbon dioxide mixture is relatively enriched in carbon-13 isotopes. The resulting carbon products derived from this carbon dioxide mixture and including carbon sourced from above-ground gases (e.g., air, flue gas, byproducts of calcining or fermentation)—including methane, graphene, graphite, carbon black, carbon nanotubes, etc.—can therefore be similarly enriched in carbon-13 isotopes relative carbon product counterparts including carbon sourced from the ground.

### 8.1.1 Point-Source Capture

In one implementation, the carbon dioxide mixture can be extracted from a volume of gas via point-source capture. The carbon dioxide mixture can therefore exhibit a relatively high concentration of carbon dioxide, such as in comparison to carbon dioxide extracted from atmospheric air via direct air capture. For example, the carbon dioxide mixture can be extracted from a flue stack of a natural gas and/or industrial facility—such as a paper mill, a cement manufacturing facility, a fermentation facility, a refinery, etc.—and/or from a byproduct of a process, such as in calcining or fermentation.

In particular, exhaust gases include a relatively higher concentration of carbon dioxide than atmospheric air. Therefore, in this implementation, the carbon dioxide mixture can be extracted from exhaust gases—rather than atmospheric air—and thus exhibit a relatively high concentration of carbon dioxide, such as exceeding 80% carbon dioxide.

Furthermore, this carbon dioxide mixture—captured via point source—can include carbon including a first amount of carbon-13 isotopes and a second amount of carbon-12 isotopes. This carbon dioxide mixture can define a ratio of the first amount of carbon-13 isotopes to the second amount of carbon-12 isotopes exceeding −45 parts-per-thousand-versus-PDB-standard and falling below −15 parts-per-thousand-versus-PDB-standard.

In particular, in one example, the carbon dioxide mixture exhibits a ratio of the first amount of carbon-13 isotopes to the second amount of carbon-12 isotopes between −40 and −20 parts-per-thousand-versus-PDB-standard. The carbon dioxide mixture can then be further processed in order to remove impurities and thus achieve a final concentration of carbon dioxide exceeding a threshold concentration (e.g., 90.0 percent, 95.0 percent, 99.9 percent). By capturing the carbon dioxide mixture via point-source capture, energy and resources dedicated to capturing and/or purifying the carbon dioxide mixture—in order to achieve at least the threshold concentration of carbon dioxide—can be minimized.

Generally, in this implementation, the carbon dioxide mixture can be captured via point-source capture via a particular capture process and of a particular fuel type. For example, the carbon dioxide mixture can be captured via point-source capture via an amine capture process, a gasification process, an oxyfuel process, etc. Furthermore, in each of these examples, the carbon dioxide mixture can be sourced from exhaust gases—via a particular capture process—of a particular fuel, such as coal, biomass, lignite, natural gas, etc. The carbon dioxide mixture—extracted via point-source capture—can therefore exhibit a particular concentration of carbon dioxide corresponding to the particular capture process (e.g., amine capture, gasification, oxyfuel) and the fuel type (e.g., coal, biomass, lignite, natural gas).

Furthermore, the carbon dioxide mixture—including a first amount of carbon-13 isotopes and a second amount of carbon-12 isotopes—can define a ratio of the first amount of carbon-13 isotopes to the second amount of carbon-12 isotopes (or a “δ13C signature”) corresponding to the particular capture process and the fuel type.

For example, a first carbon dioxide mixture—extracted from exhaust gases of coal via an amine capture process—can exhibit a δ13C between −20 parts-per-thousand-versus-PDB-standard and −30 parts-per-thousand-versus-PDB-standard. In another example, a second carbon dioxide mixture—extracted from exhaust gases of biomass via an amine capture process—can exhibit a δ13C between −25 parts-per-thousand-versus-PDB-standard and −35 parts-per-thousand-versus-PDB-standard. In yet another example, a third carbon dioxide mixture—extracted from exhaust gases of natural gas via an amine capture process—can exhibit a δ13C between −35 parts-per-thousand-versus-PDB-standard and −45 parts-per-thousand-versus-PDB-standard. In the preceding examples, the carbon dioxide mixture exhibits a different δ13C based on a variable fuel type of exhaust gases captured via the amine capture process.

In another example, a fourth carbon dioxide mixture—extracted from exhaust gases of natural gas via a gasification capture process—can exhibit a δ13C between −20 parts-per-thousand-versus-PDB-standard and −30 parts-per-thousand-versus-PDB-standard. The third carbon dioxide mixture and the fourth carbon dioxide mixture—both extracted from exhaust gases including natural gas—can therefore exhibit differing ratios of carbon-13 isotopes to carbon-12 isotopes due to differences in the particular capture process implemented, such as the amine capture process versus the gasification capture process. In yet another example, a fifth carbon dioxide mixture—extracted from coal via an oxyfuel combustion capture process—can exhibit a δ13C between −25 parts-per-thousand-versus-PDB-standard and −30 parts-per-thousand-versus-PDB-standard. The first carbon dioxide mixture and the fifth carbon dioxide mixture—both extracted from exhaust gases including coal—can therefore exhibit differing ratios of carbon-13 isotopes to carbon-12 isotopes due to differences in the particular capture process implemented, such as the amine capture process versus the oxyfuel combustion capture process.

### 8.1.2 Direct Air Capture

Additionally or alternatively, in one implementation, the carbon dioxide mixture can be extracted from air via direct air capture, such as from atmospheric air.

More specifically, a first mixture (e.g., a low-purity carbon dioxide mixture) can be extracted from a first air sample (e.g., via amine filtration), the first mixture including carbon dioxide and a first concentration of impurities (e.g., nitrogen), the amount of carbon dioxide defining a ratio of carbon-13 isotopes to carbon-12 isotopes. The resulting gaseous mixture (i.e., the first mixture) is a low-purity gaseous mixture of carbon dioxide (e.g., less than 80.0 percent carbon dioxide). This low-purity carbon dioxide mixture also includes concentrations of impurities found in air such as nitrogen, argon, and other gases.

In one implementation, the low purity, gaseous carbon dioxide mixture is extracted from atmospheric air via amine filtration. In particular, in this implementation, an air sample, including a first concentration of carbon dioxide, can be collected during an air capture period. An amount of carbon dioxide can then be extracted from the first air sample via filtration (e.g., amine filtration). This amount of carbon dioxide can then be heated, in a chamber, to generate a carbon dioxide mixture including a second concentration of carbon dioxide greater than the first concentration of carbon dioxide. This carbon dioxide mixture can then be stored in a container for further processing (e.g., at a second location). For example, air can be drawn into a reservoir (e.g., within a carbon capture device) defining an opening through which air enters the reservoir. The reservoir can include a filter arranged within the opening and configured to collect carbon dioxide molecules in the air flowing through the opening while enabling other particles in the air to flow through freely. Once the filter is saturated with carbon dioxide, the filter can be heated (e.g., to temperatures between 95 degrees Celsius and 120 degrees Celsius) to extract carbon dioxide gas from the filter. Upon heating the filter, the gaseous carbon dioxide mixture is released from the filter. This gaseous carbon dioxide mixture can then be collected and stored (e.g., in a container). Later, the gaseous carbon dioxide mixture (e.g., stored in the container) can be ingested for further processing.

In the preceding implementation, the carbon dioxide mixture can be processed further to increase a concentration of carbon dioxide mixture and reduce a concentration of impurities (e.g., argon, nitrogen) present in the carbon dioxide mixture.

For example, direct air capture via amine filtration results in a low-purity gaseous carbon dioxide mixture exhibiting a carbon dioxide concentration between seventy percent and eighty-five percent. In particular, in this example, the low-purity gaseous carbon dioxide mixture exhibits an impurity concentration between fifteen percent and thirty percent, the impurity concentration including a concentration of nitrogen (e.g., in the form of NX compounds such as nitrogen oxides and/or ammonia). However, nitrogen can be toxic to diamond crystal growth if present in the diamond reactor. Therefore, this initial low purity gaseous carbon dioxide mixture can be further treated to increase the concentration of carbon dioxide and reduce the concentration of impurities in the mixture. In particular, the low purity gaseous carbon dioxide mixture can be purified via a liquefaction technique to reduce the concentration of nitrogen (e.g., in NX compounds) in the carbon dioxide mixture.

Furthermore, this carbon dioxide mixture—captured via direct air capture—can include carbon including a first amount of carbon-13 isotopes and a second amount of carbon-12 isotopes. This carbon dioxide mixture can define a ratio of the first amount of carbon-13 isotopes to the second amount of carbon-12 isotopes exceeding −20 parts-per-thousand-versus-PDB-standard and less than zero parts-per-thousand-versus-PDB-standard. For example, a first instance of the carbon dioxide mixture—extracted from atmospheric air via direct air capture—can define a ratio of the first amount of carbon-13 isotopes to the second amount of carbon-12 isotopes within a threshold deviation (e.g., 5 parts-per-thousand-versus-PDB-standard) of −12.0 parts-per-thousand-versus-PDB-standard.

### 8.2 Carbon Products: Methane

The method S100 recites: in a methanation reactor, reacting the carbon dioxide mixture with a stream of hydrogen, in the presence of a catalyst, to generate a hydrocarbon mixture including methane and a set of impurities (e.g., carbon dioxide, hydrogen, water) via methanation of the carbon dioxide mixture.

The hydrocarbon mixture can define a second ratio of carbon-13 isotopes to carbon-12 isotopes less than a first ratio of carbon-13 isotopes to carbon-12 isotopes defined by the carbon dioxide mixture. Therefore, the resulting hydrocarbon mixture is more depleted in carbon-13 isotopes than the input carbon dioxide mixture.

### 8.2.1 Process: Gas Capture to Methane

Generally, a methane composition 120 can be generated by: capturing a gaseous mixture of carbon dioxide and other components found in air (e.g., nitrogen, argon, etc.) from an air source, such as via point-source air capture and/or direct air capture; processing this gaseous mixture of carbon dioxide and other components—according to various chemical techniques and/or in combination with additional components—to form a hydrocarbon precursor including methane gas. This hydrocarbon precursor can then be further processed and/or filtered to extract high-purity methane gas (e.g., exceeding 95% methane gas) from the hydrocarbon precursor to derive the methane composition 120.

In one implementation, the methane composition 120 can define a concentration of methane exceeding 99.50 percent. Additionally or alternatively, in another implementation, the methane composition 120 can define a concentration of methane exceeding 99.95 percent.

For example, the methane composition 120 can be generated by: exposing the carbon dioxide mixture to a stream of hydrogen—within a methanation reactor—to convert carbon dioxide, present in the carbon dioxide mixture, to a hydrocarbon mixture including methane and a set of impurities (e.g., carbon dioxide, hydrogen, water). The hydrocarbon mixture can define a concentration of methane exceeding a lower threshold concentration, such as exceeding 95% methane. This hydrocarbon mixture can then be further processed via an ultra-high pressure filtration system to separate impurities from methane present in the hydrocarbon mixture and therefore generate the methane composition 120—forming methane—defining a methane concentration exceeding an upper threshold concentration, such as exceeding 99.95% methane.

The methane composition 120 can then be collected and/or stored for distribution and/or consumption on-site (e.g., at location of production). Additionally or alternatively, the methane composition 120 can be further processed to generate one or more carbon products—such as including graphite, graphene, carbon black, carbon nanotubes, diamonds, etc.—as described below.

### 8.2.2 Isotopic Ratio: Methane

The methane composition 120 includes carbon sourced from a captured gas (e.g., via point source capture and/or direct air capture) and including: a first amount of carbon-13 isotopes; and a second amount of carbon-12 isotopes.

Generally, the methane composition 120 can define a ratio of carbon-13 isotopes to carbon-12 isotopes less than a ratio of carbon-13 to carbon-12 isotopes defined by the carbon dioxide mixture. Therefore, the methane composition 120 can include a lesser concentration of carbon-13 isotopes than the carbon dioxide mixture due to methanation of carbon dioxide in the carbon dioxide mixture and further filtration—via a set of porous filters—of methane to form the methane composition 120.

In one implementation, the methane composition 120 can define a ratio of the first amount of carbon-13 isotopes to the second amount of carbon-12 isotopes exceeding −45 parts-per-thousand-versus-PDB-standard.

In one example, the methane composition 120 includes carbon—extracted from a volume of gas via point-source capture—defining a ratio of the first amount of carbon-13 isotopes to the second amount of carbon-12 isotopes exceeding −45 parts-per-thousand-versus-PDB-standard and less than −20 parts-per-thousand-versus-PDB-standard. For example, a methane composition 120 including carbon extracted from a volume of gas via point-source capture—via amine capture of carbon dioxide from exhaust including coal—can define a ratio of the first amount of carbon-13 isotopes to the second amount of carbon-12 isotopes of approximately (e.g., within 10 percent) −25.0 parts-per-thousand-versus-PDB-standard. In this example, the carbon dioxide mixture can define a ratio of a third amount of carbon-13 isotopes to the fourth amount of carbon-12 isotopes of approximately (e.g., within 10 percent) −23.0 parts-per-thousand-versus-PDB-standard. In another example, a methane composition 120 including carbon extracted from a volume of gas via point-source capture—via amine capture of carbon dioxide from exhaust including natural gas—can define a ratio of the first amount of carbon-13 isotopes to the second amount of carbon-12 isotopes of approximately (e.g., within 10 percent) −40.0 parts-per-thousand-versus-PDB-standard. In this example, the carbon dioxide mixture can define a ratio of a third amount of carbon-13 isotopes to the fourth amount of carbon-12 isotopes of approximately (e.g., within 10 percent) −38.0 parts-per-thousand-versus-PDB-standard.

In one example, the methane composition 120 includes carbon—extracted from air via direct air capture—defining a ratio of the first amount of carbon-13 isotopes to the second amount of carbon-12 isotopes exceeding −20 parts-per-thousand-versus-PDB-standard and less than zero parts-per-thousand-versus-PDB-standard. For example, a methane composition 120 including carbon extracted from air via direct air capture—via amine capture of carbon dioxide from atmospheric air—can define a ratio of the first amount of carbon-13 isotopes to the second amount of carbon-12 isotopes of approximately (e.g., within 10 percent) −12.0 parts-per-thousand-versus-PDB-standard. In this example, the carbon dioxide mixture can define a ratio of a third amount of carbon-13 isotopes to the fourth amount of carbon-12 isotopes of approximately (e.g., within 10 percent) −10.0 parts-per-thousand-versus-PDB-standard.

### 8.3 Carbon Products: Graphene

In one implementation, the methane composition 120 can be further processed to generate a graphene composition 104 (i.e., graphene) including carbon sourced from a volume of gas (e.g., via point source capture or direct air capture).

### 8.3.1 Process: Gas Capture to Graphene

Generally, the graphene composition 104 can be generated by: capturing a gaseous mixture of carbon dioxide and other components found in a point source (e.g., a a flue gas) and/or atmospheric air (e.g., nitrogen, argon, etc.) from a volume of gas, such as via point-source capture and/or direct air capture; processing this gaseous mixture of carbon dioxide and other components—according to various chemical techniques and/or in combination with additional components—to form a hydrocarbon precursor (e.g., methane gas); and further processing and/or reacting this hydrocarbon precursor to form the graphene composition 104.

Generally, the graphene composition 104 can be generated via: heating of the hydrocarbon mixture (i.e., the methane composition 120) within a graphene reactor—according to a target heating protocol corresponding to graphene—to dissociate carbon from hydrogen within the graphene reactor; and cooling carbon collected from the graphene reactor according to a target cooling protocol—defining a particular rate of cooling and corresponding to graphene—to form graphene. In particular, the high-purity hydrocarbon mixture (i.e., the methane composition 120) can be exposed to conditions within the graphene reactor—according to the target heating and/or cooling protocols—to convert methane to solid carbon and hydrogen (e.g., dissociated from the solid carbon). As described above, the hydrocarbon mixture—including methane including carbon sourced from a particular gas (e.g., via point source capture or direct air capture)—is formed via methanation of the carbon dioxide mixture extracted from a volume of gas (e.g., air, a point source) and including carbon dioxide and impurities.

Generally, to generate the graphene composition 104, the heating and/or cooling protocols can be selected to convert methane to graphene within the graphene reactor. However, these heating and/or cooling protocols can be modified in order to generate other compositions, such as the graphite composition 102 and/or the carbon black composition 106, as described further below.

In one implementation, the graphene composition 104 can be formed within the graphene reactor via a microwave deposition process (e.g., microwave pyrolysis) including: heating the hydrocarbon mixture to a first target temperature—according to a first target heating rate corresponding to graphene—within a graphene reactor to dissociate carbon from hydrogen within the graphene reactor; and cooling carbon—separated from hydrogen—according to a first target cooling rate configured to promote generation of graphene within the graphene reactor. In another implementation, the graphene composition 104 can be formed within the graphene reactor via a plasma pyrolysis including: heating the hydrocarbon mixture to a second target temperature—according to a second target heating rate corresponding to graphene—within a graphene reactor to dissociate carbon from hydrogen within the graphene reactor; and cooling carbon—separated from hydrogen—according to a second target cooling rate configured to promote generation of graphene within the graphene reactor.

### 8.3.2 Isotopic Ratio: Graphene

Generally, the graphene composition 104 can include carbon sourced from a volume of gas (e.g., air, a point source) and including a first amount of carbon-13 isotopes and a second amount of carbon-12 isotopes. The graphene composition 104 can exhibit an isotopic signature defining a ratio of the first amount of carbon-13 isotopes to the second amount of carbon-12 isotopes exceeding −50.0 parts-per-thousand-versus-PDB-standard.

Generally, the graphene composition 104 can define a ratio of carbon-13 isotopes to carbon-12 isotopes less than a ratio of carbon-13 to carbon-12 isotopes defined by the carbon dioxide mixture and the hydrocarbon mixture (i.e., the methane composition 120). Therefore, the graphene composition 104 can include a lesser concentration of carbon-13 isotopes than the carbon dioxide mixture—and the hydrocarbon mixture—due to reaction of hydrocarbons in the graphene reactor during formation of graphene.

In particular, in one implementation, the graphene composition 104 can: include carbon sourced from a volume of gas via point source capture; and exhibit an isotopic signature defining a ratio of the first amount of carbon-13 isotopes to the second amount of carbon-12 isotopes exceeding −45.0 parts-per-thousand-versus-PDB-standard and less than −15 parts-per-thousand-versus-PDB-standard. In particular, in this implementation, the graphene composition 104 can be: derived from a hydrocarbon mixture (i.e., the methane composition 120) extracted from a volume of gas (e.g., a flue stack) via a point source capture process; and exhibit the isotopic signature defining the ratio of the first amount of carbon-13 isotopes to the second amount of carbon-12 isotopes exceeding −50.0 parts-per-thousand-versus-PDB-standard and less than −15.0 parts-per-thousand-versus-PDB-standard.

For example, a first instance of the graphene composition 104—including carbon extracted via point-source capture—via amine capture of carbon dioxide from exhaust including natural gas—can define a ratio of the first amount of carbon-13 isotopes to the second amount of carbon-12 isotopes of approximately (e.g., within 10 percent) −42.0 parts-per-thousand-versus-PDB-standard. In another example, a second instance of the graphene composition 104—including carbon extracted via point-source capture—via amine capture of carbon dioxide from exhaust including coal—can define a ratio of the first amount of carbon-13 isotopes to the second amount of carbon-12 isotopes of approximately (e.g., within 10 percent) −28.0 parts-per-thousand-versus-PDB-standard.

In another implementation, the graphene composition 104 can: include carbon sourced from air via direct air capture; and exhibit an isotopic signature defining a ratio of the first amount of carbon-13 isotopes to the second amount of carbon-12 isotopes exceeding −20.0 parts-per-thousand-versus-PDB-standard and less than zero parts-per-thousand-versus-PDB-standard. In particular, in this implementation, the graphene composition 104 can be: derived from a hydrocarbon mixture (i.e., the methane composition 120) extracted from air via a direct air capture process; and exhibit the isotopic signature defining the ratio of the first amount of carbon-13 isotopes to the second amount of carbon-12 isotopes exceeding −20.0 parts-per-thousand-versus-PDB-standard and less than zero parts-per-thousand-versus-PDB-standard. In particular, in one example, an instance of the graphene composition 104—including carbon—extracted from air via direct air capture of atmospheric air—can define a ratio of the first amount of carbon-13 isotopes to the second amount of carbon-12 isotopes of approximately (e.g., within 10 percent) −16.0 parts-per-thousand-versus-PDB-standard

The graphene composition 104 can therefore exhibit a variable concentration of carbon-13 isotopes—and therefore a variable isotopic signature—based on a type of gas capture (e.g., direct air capture, point source capture) employed during capturing of the initial carbon dioxide mixture.

Furthermore, the graphene composition 104 can exhibit a variable concentration of carbon-13 isotopes—and therefore a variable isotopic signature—based on a conversion process employed for converting methane to graphene during generation of the graphene composition 104.

In particular, in one implementation, the graphene composition 104 can be formed via plasma pyrolysis of the hydrocarbon mixture including methane derived from carbon dioxide extracted from a volume of gas via point source capture. In this implementation, the graphene composition 104 can exhibit an isotopic signature defining a ratio of the first amount of carbon-13 isotopes to the second amount of carbon-12 isotopes exceeding −50.0 parts-per-thousand-versus-PDB-standard and less than −15 parts-per-thousand-versus-PDB-standard.

In another implementation, the graphene composition 104 can be formed via microwave deposition of the hydrocarbon mixture including methane derived from carbon dioxide extracted from a volume of gas via point source capture. In this implementation, the graphene composition 104 can exhibit an isotopic signature defining a ratio of the first amount of carbon-13 isotopes to the second amount of carbon-12 isotopes exceeding −45.0 parts-per-thousand-versus-PDB-standard and less than −10 parts-per-thousand-versus-PDB-standard.

In each of these implementations, the graphene composition 104 can exhibit an isotopic signature—defining a ratio of carbon-13 isotopes to carbon-12 isotopes—corresponding to a conversion rate of methane to graphene during conversion of the methane composition 120 to the graphene composition 104. For example, a first instance of the graphene composition 104 formed via plasma pyrolysis—defining a once-through conversion rate exceeding 80% conversion—of the methane composition 120 can exhibit an isotopic ratio defining a ratio of the carbon-13 isotopes to carbon-12 isotopes within a first range (e.g., between −15 parts-per-thousand-versus-PDB-standard and −50 parts-per-thousand-versus-PDB-standard). A second instance of the graphene composition 104 formed via microwave deposition—defining a once-through conversion rate less than 80% conversion—of the methane composition 120 can exhibit an isotopic ratio defining a ratio of the carbon-13 isotopes to carbon-12 isotopes within a second range exceeding the first range, such that the first instance of the graphene composition 104 defines a lower concentration of carbon-13 isotopes than the second instance of the graphene composition 104.

Additionally, in one implementation, the graphene composition 104 can include carbon sourced from a volume of gas (e.g., a point source, atmospheric air)—and/or exclude carbon sourced from ground (e.g., via mining)—and define a concentration of carbon-13 within a first concentration range, concentrations of carbon-13 within the first concentration range exceeding an average concentration of carbon-13 exhibited by graphene including carbon sourced from ground. The graphene composition 104—including carbon sourced from a volume of gas (e.g., via point source capture or direct air capture)—can therefore define an isotopic signature different from isotopic signatures of graphene including carbon sourced from the ground, due to relatively higher concentrations of carbon-13 isotopes in the graphene composition 104 and relatively lower concentrations of carbon-13 isotopes in graphene formed from ground-sourced carbon.

For example, an instance of the graphene composition 104 can exhibit an isotopic signature defining the ratio of the first amount of carbon-13 isotopes to the second amount of carbon-12 isotopes exceeding −40.0 parts-per-thousand-versus-PDB-standard. However, an amount of graphene including carbon sourced from the ground can exhibit an isotopic signature defining the ratio of a third amount of carbon-13 isotopes to a fourth amount of carbon-12 isotopes less than −50.0 parts-per-thousand-versus-PDB-standard.

### 8.4 Carbon Products: Graphite

In one implementation, the methane composition 120 can be further processed to generate a graphite composition 102 (i.e., graphite) including carbon sourced from a volume of gas (e.g., via point source capture or direct air capture).

### 8.4.1 Process: Gas Capture to Graphite

Generally, the graphite composition 102 can be generated by: capturing a gaseous mixture of carbon dioxide and other components found in a point source (e.g., a flue gas) and/or atmospheric air (e.g., nitrogen, argon, etc.) from a volume of gas, such as via point-source capture and/or direct air capture; processing this gaseous mixture of carbon dioxide and other components—according to various chemical techniques and/or in combination with additional components—to form a hydrocarbon precursor (e.g., methane gas); and further processing and/or reacting this hydrocarbon precursor to form the graphite composition 102.

Generally, the graphite composition 102 can be generated via: heating of the hydrocarbon mixture (i.e., the methane composition 120) within a graphite reactor—according to a target heating protocol corresponding to graphite—to dissociate carbon from hydrogen within the graphite reactor; and cooling carbon collected from the graphite reactor according to a target cooling protocol—defining a particular rate of cooling and corresponding to graphite—to form graphite. In particular, the high-purity hydrocarbon mixture (i.e., the methane composition 120) can be exposed to conditions within the graphite reactor—according to the target heating and/or cooling protocols—to convert methane to solid carbon and hydrogen (e.g., dissociated from the solid carbon). As described above, the hydrocarbon mixture—including methane including carbon sourced from a particular gas (e.g., via point source capture or direct air capture)—is formed via methanation of the carbon dioxide mixture extracted from a volume of gas (e.g., air, a point source) and including carbon dioxide and impurities.

Generally, to generate the graphite composition 102, the heating and/or cooling protocols can be selected to convert methane to graphite within the graphite reactor. However, these heating and/or cooling protocols can be modified in order to generate other compositions, such as the graphite composition 102 and/or the carbon black composition 106, as described further below.

In one implementation, the graphite composition 102 can be formed within the graphite reactor via a microwave deposition process (e.g., microwave pyrolysis) including: heating the hydrocarbon mixture to a third target temperature—according to a third target heating rate corresponding to graphite—within a graphite reactor to dissociate carbon from hydrogen within the graphite reactor; and cooling carbon—separated from hydrogen—according to a third target cooling rate configured to promote generation of graphite within the graphite reactor. In another implementation, the graphite composition 102 can be formed within the graphite reactor via a plasma pyrolysis process including: heating the hydrocarbon mixture to a fourth target temperature—according to a fourth target heating rate corresponding to graphite—within a graphite reactor to dissociate carbon from hydrogen within the graphite reactor; and cooling carbon—separated from hydrogen—according to a fourth target cooling rate configured to promote generation of graphite within the graphite reactor.

### 8.4.2 Isotopic Ratio: Graphite

Generally, the graphite composition 102 can include carbon sourced from a volume of gas (e.g., air, a point source) and including a first amount of carbon-13 isotopes and a second amount of carbon-12 isotopes. The graphite composition 102 can exhibit an isotopic signature defining a ratio of the first amount of carbon-13 isotopes to the second amount of carbon-12 isotopes exceeding −50.0 parts-per-thousand-versus-PDB-standard.

Generally, the graphite composition 102 can define a ratio of carbon-13 isotopes to carbon-12 isotopes less than a ratio of carbon-13 to carbon-12 isotopes defined by the carbon dioxide mixture and the hydrocarbon mixture (i.e., the methane composition 120). Therefore, the graphite composition 102 can include a lesser concentration of carbon-13 isotopes than the carbon dioxide mixture—and the hydrocarbon mixture—due to reaction of hydrocarbons in the graphite reactor during formation of graphite.

In particular, in one implementation, the graphite composition 102 can: include carbon sourced from a volume of gas via point source capture; and exhibit an isotopic signature defining a ratio of the first amount of carbon-13 isotopes to the second amount of carbon-12 isotopes exceeding −45.0 parts-per-thousand-versus-PDB-standard and less than −15 parts-per-thousand-versus-PDB-standard. In particular, in this implementation, the graphite composition 102 can: be derived from a hydrocarbon mixture (i.e., the methane composition 120) extracted from a volume of gas (e.g., a flue stack) via a point source capture process; and exhibit the isotopic signature defining the ratio of the first amount of carbon-13 isotopes to the second amount of carbon-12 isotopes exceeding −50.0 parts-per-thousand-versus-PDB-standard and less than −15.0 parts-per-thousand-versus-PDB-standard.

For example, a first instance of the graphite composition 102—including carbon extracted via point-source capture—via amine capture of carbon dioxide from exhaust including natural gas—can define a ratio of the first amount of carbon-13 isotopes to the second amount of carbon-12 isotopes of approximately (e.g., within 10 percent) −42.0 parts-per-thousand-versus-PDB-standard. In another example, a second instance of the graphite composition 102—including carbon extracted via point-source capture—via amine capture of carbon dioxide from exhaust including coal—can define a ratio of the first amount of carbon-13 isotopes to the second amount of carbon-12 isotopes of approximately (e.g., within 10 percent) −28.0 parts-per-thousand-versus-PDB-standard.

In another implementation, the graphite composition 102 can: include carbon sourced from air via direct air capture; and exhibit an isotopic signature defining a ratio of the first amount of carbon-13 isotopes to the second amount of carbon-12 isotopes exceeding −20.0 parts-per-thousand-versus-PDB-standard and less than zero parts-per-thousand-versus-PDB-standard. In particular, in this implementation, the graphite composition 102 can: be derived from a hydrocarbon mixture (i.e., the methane composition 120) extracted from air via a direct air capture process; and exhibit the isotopic signature defining the ratio of the first amount of carbon-13 isotopes to the second amount of carbon-12 isotopes exceeding −20.0 parts-per-thousand-versus-PDB-standard and less than zero parts-per-thousand-versus-PDB-standard. In particular, in one example, an instance of the graphite composition 102—including carbon—extracted from air via direct air capture of atmospheric air—can define a ratio of the first amount of carbon-13 isotopes to the second amount of carbon-12 isotopes of approximately (e.g., within 10 percent) −16.0 parts-per-thousand-versus-PDB-standard

The graphite composition 102 can therefore exhibit a variable concentration of carbon-13 isotopes—and therefore a variable isotopic signature—based on a type of gas capture (e.g., direct air capture, point source capture) employed during capturing of the initial carbon dioxide mixture.

Furthermore, the graphite composition 102 can exhibit a variable concentration of carbon-13 isotopes—and therefore a variable isotopic signature—based on a conversion process employed for converting methane to graphite during generation of the graphite composition 102.

In particular, in one implementation, the graphite composition 102 can be formed via plasma pyrolysis of the hydrocarbon mixture including methane derived from carbon dioxide extracted from a volume of gas via point source capture. In this implementation, the graphite composition 102 can exhibit an isotopic signature defining a ratio of the first amount of carbon-13 isotopes to the second amount of carbon-12 isotopes exceeding −50.0 parts-per-thousand-versus-PDB-standard and less than −15 parts-per-thousand-versus-PDB-standard.

In another implementation, the graphite composition 102 can be formed via microwave deposition of the hydrocarbon mixture including methane derived from carbon dioxide extracted from air a volume of gas point source capture. In this implementation, the graphite composition 102 can exhibit an isotopic signature defining a ratio of the first amount of carbon-13 isotopes to the second amount of carbon-12 isotopes exceeding −45.0 parts-per-thousand-versus-PDB-standard and less than −10 parts-per-thousand-versus-PDB-standard.

In each of these implementations, the graphite composition 102 can exhibit an isotopic signature—defining a ratio of carbon-13 isotopes to carbon-12 isotopes—corresponding to a conversion rate of methane to graphite during conversion of the methane composition 120 to the graphite composition 102. For example, a first instance of the graphite composition 102 formed via plasma pyrolysis—defining a once-through conversion rate exceeding 80% conversion—of the methane composition 120 can exhibit an isotopic ratio defining a ratio of the carbon-13 isotopes to carbon-12 isotopes within a first range (e.g., between −15 parts-per-thousand-versus-PDB-standard and −50 parts-per-thousand-versus-PDB-standard). A second instance of the graphite composition 102 formed via microwave deposition—defining a once-through conversion rate less than 80% conversion—of the methane composition 120 can exhibit an isotopic ratio defining a ratio of the carbon-13 isotopes to carbon-12 isotopes within a second range exceeding the first range, such that the first instance of the graphite composition 102 defines a lower concentration of carbon-13 isotopes than the second instance of the graphite composition 102.

Additionally, in one implementation, the graphite composition 102 can include carbon sourced from a volume of gas (e.g., a point source, atmospheric air)—and/or exclude carbon sourced from ground (e.g., via mining)—and define a concentration of carbon-13 within a first concentration range, concentrations of carbon-13 within the first concentration range exceeding an average concentration of carbon-13 exhibited by graphite including carbon sourced from ground. The graphite composition 102—including carbon sourced from a volume of gas (e.g., via point source capture or direct air capture)—can therefore define an isotopic signature different from isotopic signatures of graphite including carbon sourced from the ground, due to increased concentrations of carbon-13 isotopes in the graphite composition 102 relative concentrations of carbon-13 isotopes in graphite formed from ground-sourced carbon.

For example, an instance of the graphite composition 102 can exhibit an isotopic signature defining the ratio of the first amount of carbon-13 isotopes to the second amount of carbon-12 isotopes exceeding −40.0 parts-per-thousand-versus-PDB-standard. However, an amount of graphite including carbon sourced from the ground can exhibit an isotopic signature defining the ratio of a third amount of carbon-13 isotopes to a fourth amount of carbon-12 isotopes less than −50.0 parts-per-thousand-versus-PDB-standard.

### 8.5 Carbon Products: Carbon Black

In one implementation, the methane composition 120 can be further processed to generate a carbon black composition 106 (i.e., carbon black) including carbon sourced from a volume of gas (e.g., via point source capture or direct air capture).

### 8.5.1 Process: Gas Capture to Carbon Black

Generally, the carbon black composition 106 can be generated by: capturing a gaseous mixture of carbon dioxide and other components found in a point source (e.g., a flue gas) and/or atmospheric air (e.g., nitrogen, argon, etc.) from a volume of gas, such as via point-source capture and/or direct air capture; processing this gaseous mixture of carbon dioxide and other components—according to various chemical techniques and/or in combination with additional components—to form a hydrocarbon precursor (e.g., methane gas); and further processing and/or reacting this hydrocarbon precursor to form the carbon black composition 106.

Generally, the carbon black composition 106 can be generated via: heating of the hydrocarbon mixture (i.e., the methane composition 120) within a carbon black reactor—according to a target heating protocol corresponding to carbon black—to dissociate carbon from hydrogen within the carbon black reactor; and cooling carbon collected from the carbon black reactor according to a target cooling protocol—defining a particular rate of cooling and corresponding to carbon black—to form carbon black. In particular, the high-purity hydrocarbon mixture (i.e., the methane composition 120) can be exposed to conditions within the carbon black reactor—according to the target heating and/or cooling protocols—to convert methane to solid carbon and hydrogen (e.g., dissociated from the solid carbon). As described above, the hydrocarbon mixture—including methane including carbon sourced from a particular gas (e.g., via point source capture or direct air capture)—is formed via methanation of the carbon dioxide mixture extracted from a volume of gas (e.g., air, a point source) and including carbon dioxide and impurities.

Generally, to generate the carbon black composition 106, the heating and/or cooling protocols can be selected to convert methane to carbon black within the graphene reactor. However, these heating and/or cooling protocols can be modified in order to generate other compositions, such as the graphene composition 104 and/or the graphite composition 102, as described above.

In one implementation, the carbon black composition 106 can be formed within the carbon black reactor via a microwave deposition process (e.g., microwave pyrolysis) including: heating the hydrocarbon mixture to a fifth target temperature—according to a fifth target heating rate corresponding to carbon black—within a carbon black reactor to dissociate carbon from hydrogen within the carbon black reactor; and cooling carbon—separated from hydrogen—according to a fifth target cooling rate configured to promote generation of carbon black within the carbon black reactor. In another implementation, the carbon black composition 106 can be formed within the carbon black reactor via a plasma pyrolysis process including: heating the hydrocarbon mixture to a sixth target temperature—according to a sixth target heating rate corresponding to carbon black—within a carbon black reactor to dissociate carbon from hydrogen within the carbon black reactor; and cooling carbon—separated from hydrogen—according to a sixth target cooling rate configured to promote generation of carbon black within the carbon black reactor.

### 8.5.2 Isotopic Ratio: Carbon Black

Generally, the carbon black composition 106 can include carbon sourced from a volume of gas (e.g., air, a point source) and including a first amount of carbon-13 isotopes and a second amount of carbon-12 isotopes. The carbon black composition 106 can exhibit an isotopic signature defining a ratio of the first amount of carbon-13 isotopes to the second amount of carbon-12 isotopes exceeding −50.0 parts-per-thousand-versus-PDB-standard.

Generally, the carbon black composition 106 can define a ratio of carbon-13 isotopes to carbon-12 isotopes less than a ratio of carbon-13 to carbon-12 isotopes defined by the carbon dioxide mixture and the hydrocarbon mixture (i.e., the methane composition 120). Therefore, the carbon black composition 106 can include a lesser concentration of carbon-13 isotopes than the carbon dioxide mixture—and the hydrocarbon mixture—due to reaction of hydrocarbons in the carbon black reactor during formation of carbon black.

In particular, in one implementation, the carbon black composition 106 can: include carbon sourced from a volume of gas via point source capture; and exhibit an isotopic signature defining a ratio of the first amount of carbon-13 isotopes to the second amount of carbon-12 isotopes exceeding −50.0 parts-per-thousand-versus-PDB-standard and less than −20 parts-per-thousand-versus-PDB-standard. In particular, in this implementation, the carbon black composition 106 can: be derived from a hydrocarbon mixture (i.e., the methane composition 120) extracted from a volume of gas (e.g., a flue stack) via a point source capture process; and exhibit the isotopic signature defining the ratio of the first amount of carbon-13 isotopes to the second amount of carbon-12 isotopes exceeding −50.0 parts-per-thousand-versus-PDB-standard and less than −20.0 parts-per-thousand-versus-PDB-standard.

For example, a first instance of the carbon black composition 106—including carbon extracted via point-source capture—via amine capture of carbon dioxide from exhaust including natural gas—can define a ratio of the first amount of carbon-13 isotopes to the second amount of carbon-12 isotopes of approximately (e.g., within 10 percent) −44.0 parts-per-thousand-versus-PDB-standard. In another example, a second instance of the carbon black composition 106—including carbon extracted via point-source capture—via amine capture of carbon dioxide from exhaust including coal—can define a ratio of the first amount of carbon-13 isotopes to the second amount of carbon-12 isotopes of approximately (e.g., within 10 percent) −30.0 parts-per-thousand-versus-PDB-standard.

In another implementation, the carbon black composition 106 can: include carbon sourced from air via direct air capture; and exhibit an isotopic signature defining a ratio of the first amount of carbon-13 isotopes to the second amount of carbon-12 isotopes exceeding −20.0 parts-per-thousand-versus-PDB-standard and less than zero parts-per-thousand-versus-PDB-standard. In particular, in this implementation, the carbon black composition 106 can be: derived from a hydrocarbon mixture (i.e., the methane composition 120) extracted from air via a direct air capture process; and exhibit the isotopic signature defining the ratio of the first amount of carbon-13 isotopes to the second amount of carbon-12 isotopes exceeding −25.0 parts-per-thousand-versus-PDB-standard and less than −5 parts-per-thousand-versus-PDB-standard. In particular, in one example, an instance of the carbon black composition 106—including carbon—extracted from air via direct air capture of atmospheric air—can define a ratio of the first amount of carbon-13 isotopes to the second amount of carbon-12 isotopes of approximately (e.g., within 10 percent) −18.0 parts-per-thousand-versus-PDB-standard.

The carbon black composition 106 can therefore exhibit a variable concentration of carbon-13 isotopes—and therefore a variable isotopic signature—based on a type of air capture (e.g., direct air capture, point source capture) employed during capturing of the initial carbon dioxide mixture. Furthermore, the carbon black composition 106 can exhibit a variable concentration of carbon-13 isotopes—and therefore a variable isotopic signature—based on a conversion process employed for converting methane to graphene during generation of the carbon black composition 106.

In particular, in one implementation, the graphene composition 104 can be formed via plasma pyrolysis of the hydrocarbon mixture including methane derived from carbon dioxide extracted from a volume of gas via point source capture. In this implementation, the carbon black composition 106 can exhibit an isotopic signature defining a ratio of the first amount of carbon-13 isotopes to the second amount of carbon-12 isotopes exceeding −50.0 parts-per-thousand-versus-PDB-standard and less than −20 parts-per-thousand-versus-PDB-standard.

In another implementation, the carbon black composition 106 can be formed via microwave deposition of the hydrocarbon mixture including methane derived from carbon dioxide extracted from a volume of gas via point source capture. In this implementation, the graphene composition 104 can exhibit an isotopic signature defining a ratio of the first amount of carbon-13 isotopes to the second amount of carbon-12 isotopes exceeding −45.0 parts-per-thousand-versus-PDB-standard and less than −15 parts-per-thousand-versus-PDB-standard.

In each of these implementations, the carbon black composition 106 can exhibit an isotopic signature—defining a ratio of carbon-13 isotopes to carbon-12 isotopes—corresponding to a conversion rate of methane to carbon black during conversion of the methane composition 120 to the carbon black composition 106. For example, a first instance of the carbon black composition 106 formed via plasma pyrolysis—defining a once-through conversion rate exceeding 80% conversion—of the methane composition 120 can exhibit an isotopic ratio defining a ratio of the carbon-13 isotopes to carbon-12 isotopes within a first range (e.g., between −15 parts-per-thousand-versus-PDB-standard and −50 parts-per-thousand-versus-PDB-standard). A second instance of the carbon black composition 106 formed via microwave deposition—defining a once-through conversion rate less than 80% conversion—of the methane composition 120 can exhibit an isotopic ratio defining a ratio of the carbon-13 isotopes to carbon-12 isotopes within a second range exceeding the first range, such that the first instance of the graphene composition 104s defines a lower concentration of carbon-13 isotopes than the second instance of the graphene composition 104.

Additionally, in one implementation, the carbon black composition 106 can include carbon sourced from a volume of gas (e.g., a point source, atmospheric air)—and/or exclude carbon sourced from ground (e.g., via mining)—and define a concentration of carbon-13 within a first concentration range, concentrations of carbon-13 within the first concentration range exceeding an average concentration of carbon-13 exhibited by graphene including carbon sourced from ground. The carbon black composition 106—including carbon sourced from a volume of gas (e.g., via point source capture or direct air capture)—can therefore define an isotopic signature different from isotopic signatures of carbon black including carbon sourced from the ground, due to relatively higher concentrations of carbon-13 isotopes in the carbon black composition 106 and relatively lower concentrations of carbon-13 isotopes in carbon black formed from ground-sourced carbon.

For example, an instance of the carbon black composition 106 can exhibit an isotopic signature defining the ratio of the first amount of carbon-13 isotopes to the second amount of carbon-12 isotopes exceeding −45.0 parts-per-thousand-versus-PDB-standard. However, an amount of carbon black including carbon sourced from the ground can exhibit an isotopic signature defining the ratio of a third amount of carbon-13 isotopes to a fourth amount of carbon-12 isotopes less than −50.0 parts-per-thousand-versus-PDB-standard.

### 8.6 Carbon Products: Carbon Nanotubes

In one implementation, the methane composition 120 can be further processed to generate a carbon nanotube composition 108 (i.e., carbon nanotubes) including carbon sourced from a volume of gas (e.g., via point source capture or direct air capture).

### 8.6.1 Process: Air to Carbon Nanotubes

Generally, the carbon nanotube composition 108 can be generated by: capturing a gaseous mixture of carbon dioxide and other components found in a point source (e.g., a flue gas) and/or atmospheric air (e.g., nitrogen, argon, etc.) from a volume of gas, such as via point-source capture and/or direct air capture; processing this gaseous mixture of carbon dioxide and other components—according to various chemical techniques and/or in combination with additional components—to form a hydrocarbon precursor (e.g., methane gas); and further processing and/or reacting this hydrocarbon precursor to form the carbon nanotube composition 108.

Generally, the carbon nanotube composition 108 can be generated via chemical vapor deposition of the hydrocarbon mixture (i.e., the methane composition 120) within a nanotube reactor according to a set of conditions defined for carbon nanotubes.

### 8.6.2 Isotopic Ratio: Carbon Nanotubes

Generally, the carbon nanotube composition 108 can include carbon sourced from a volume of gas (e.g., air, a point source) and including a first amount of carbon-13 isotopes and a second amount of carbon-12 isotopes. The carbon nanotube composition 108 can exhibit an isotopic signature defining a ratio of the first amount of carbon-13 isotopes to the second amount of carbon-12 isotopes exceeding −45.0 parts-per-thousand-versus-PDB-standard.

Generally, the carbon nanotube composition 108 can define a ratio of carbon-13 isotopes to carbon-12 isotopes exceeding a ratio of carbon-13 to carbon-12 isotopes defined by the carbon dioxide mixture and the hydrocarbon mixture (i.e., the methane composition 120). Therefore, the carbon nanotube composition 108 can include a greater concentration of carbon-13 isotopes than the carbon dioxide mixture—and the hydrocarbon mixture—due to chemical vapor deposition of methane in the hydrocarbon mixture during formation of the carbon nanotube composition 108 in the nanotube reactor.

In particular, in one implementation, the carbon nanotube composition 108 can: include carbon sourced from a volume of gas via point source capture; and exhibit an isotopic signature defining a ratio of the first amount of carbon-13 isotopes to the second amount of carbon-12 isotopes exceeding −45.0 parts-per-thousand-versus-PDB-standard and less than −10 parts-per-thousand-versus-PDB-standard. In particular, in this implementation, the carbon nanotube composition 108 can be: derived from a hydrocarbon mixture (i.e., the methane composition 120) extracted from a volume of gas (e.g., a flue stack) via a point source capture process; and exhibit the isotopic signature defining the ratio of the first amount of carbon-13 isotopes to the second amount of carbon-12 isotopes exceeding −45.0 parts-per-thousand-versus-PDB-standard and less than −10.0 parts-per-thousand-versus-PDB-standard.

For example, a first instance of the carbon nanotube composition 108—including carbon extracted via point-source capture—via amine capture of carbon dioxide from exhaust including natural gas—can define a ratio of the first amount of carbon-13 isotopes to the second amount of carbon-12 isotopes of approximately (e.g., within 10 percent) −34.0 parts-per-thousand-versus-PDB-standard. In another example, a second instance of the carbon nanotube composition 108—including carbon extracted via point-source capture—via amine capture of carbon dioxide from exhaust including coal—can define a ratio of the first amount of carbon-13 isotopes to the second amount of carbon-12 isotopes of approximately (e.g., within 10 percent) −19.0 parts-per-thousand-versus-PDB-standard.

In another implementation, the carbon nanotube composition 108 can: include carbon sourced from air via direct air capture; and exhibit an isotopic signature defining a ratio of the first amount of carbon-13 isotopes to the second amount of carbon-12 isotopes exceeding −15.0 parts-per-thousand-versus-PDB-standard and less than 5.0 parts-per-thousand-versus-PDB-standard. In particular, in this implementation, the carbon nanotube composition 108 can be: derived from a hydrocarbon mixture (i.e., the methane composition 120) extracted from air via a direct air capture process; and exhibit the isotopic signature defining the ratio of the first amount of carbon-13 isotopes to the second amount of carbon-12 isotopes exceeding −15.0 parts-per-thousand-versus-PDB-standard and less than 5.0 parts-per-thousand-versus-PDB-standard. In particular, in one example, an instance of the carbon nanotube composition 108—including carbon—extracted from air via direct air capture of atmospheric air—can define a ratio of the first amount of carbon-13 isotopes to the second amount of carbon-12 isotopes of approximately (e.g., within 10 percent) −6.0 parts-per-thousand-versus-PDB-standard

The carbon nanotube composition 108 can therefore exhibit a variable concentration of carbon-13 isotopes—and therefore a variable isotopic signature—based on a type of gas capture (e.g., direct air capture, point source capture) employed during capturing of the initial carbon dioxide mixture.

Additionally, in one implementation, the carbon nanotube composition 108 can include carbon sourced from a volume of gas (e.g., a point source, atmospheric air)—and/or exclude carbon sourced from ground (e.g., via mining)—and define a concentration of carbon-13 within a first concentration range, concentrations of carbon-13 within the first concentration range exceeding an average concentration of carbon-13 exhibited by carbon nanotubes including carbon sourced from ground. The carbon nanotube composition 108—including carbon sourced from a volume of gas (e.g., via point source capture or direct air capture)—can therefore define an isotopic signature different from isotopic signatures of carbon nanotubes including carbon sourced from the ground, due to increased concentrations of carbon-13 isotopes in the carbon nanotube composition 108 relative concentrations of carbon-13 isotopes in carbon nanotubes formed from ground-sourced carbon. For example, an instance of the carbon nanotube composition 108 can exhibit an isotopic signature defining the ratio of the first amount of carbon-13 isotopes to the second amount of carbon-12 isotopes exceeding −35.0 parts-per-thousand-versus-PDB-standard. However, an amount of carbon nanotube including carbon sourced from the ground can exhibit an isotopic signature defining the ratio of a third amount of carbon-13 isotopes to a fourth amount of carbon-12 isotopes less than −45.0 parts-per-thousand-versus-PDB-standard.

### 9. Linking Carbon Product to Carbon Source

In one implementation, the carbon composition 100—such as the graphene composition 104, the graphite composition 102, the methane composition 120, the carbon black composition 106, and/or the carbon nanotube composition 108—can be linked to a particular carbon source (e.g., a fuel type) and capture method based on an isotopic signature of the carbon composition 100.

In particular, in this implementation, the carbon composition 100 can exhibit variable isotopic signatures—characterized by varying concentrations of carbon-13 isotopes and carbon-12 isotopes in the carbon composition 100—based on a method of gas capture employed during extraction of the carbon dioxide mixture and a carbon source (e.g., atmospheric air, a point source) of the carbon dioxide mixture.

For example, a first instance of the carbon composition 100 can: be derived from a hydrocarbon mixture including methane including carbon sourced from a volume of gas (e.g., a point source, atmospheric air) and formed via methanation of a carbon dioxide mixture extracted from the volume of gas via a point source capture process and from exhaust of a particular fuel type (e.g., coal, lignite, biomass, natural gas); and exhibit an isotopic signature defining a ratio of a first amount of carbon-13 isotopes to a second amount of carbon-12 isotopes between −45 parts-per-thousand-versus-PDB-standard and −15 parts-per-thousand-versus-PDB-standard.

In this example, a second instance of the carbon composition 100 can: be derived from a hydrocarbon mixture including methane including carbon sourced from air and formed via methanation of a carbon dioxide mixture extracted from air via a direct air capture process and from atmospheric air; and exhibit an isotopic signature defining a ratio of a first amount of carbon-13 isotopes to a second amount of carbon-12 isotopes between −20 parts-per-thousand-versus-PDB-standard and 5 parts-per-thousand-versus-PDB-standard.

### 10. Carbon Composition: Material Properties+Isotopic Signature

In one implementation, a solid carbon product (e.g., graphene, graphite, carbon nanotubes, carbon black, diamond) formed of the carbon composition 100 can exhibit properties (e.g., electrical, chemical, optical, magnetic, physical, thermal) corresponding to an isotopic signature of the carbon composition 100. In particular, in this implementation, a solid carbon product formed of the carbon composition 100—formed of carbon sourced from a volume of gas (e.g., a point source, atmospheric air)—can exhibit a target set of material properties different from material properties exhibited by solid carbon products formed of carbon sourced from the ground. For example, a solid carbon product formed of the carbon composition 100—such as including the graphene composition 104, the graphite composition 102, the carbon black composition 106, etc.—can define a target thermal conductivity and a target electrical conductivity. However, a corresponding carbon product formed of carbon sourced from the ground can define: an average thermal conductivity less than the target thermal conductivity exhibited by the solid carbon product formed of the carbon composition 100; and an average electrical conductivity less than the target electrical conductivity exhibited by the solid carbon product formed of the carbon composition 100.

In one variation, Blocks of the method S100 can be executed to regulate a ratio of carbon-13 isotopes to carbon-12 isotopes within the carbon composition 100. In particular, in this implementation, the carbon dioxide mixture can be fed through a distillation column—as described above—to regulate amounts of carbon-13 isotopes and carbon-12 isotopes present in the carbon dioxide mixture, prior to mixing of the carbon dioxide mixture with the stream of hydrogen in the methanation reactor to form the hydrocarbon mixture (i.e., the methane composition 120).

In particular, the carbon dioxide mixture—exhibiting an initial ratio of carbon-13 isotopes to carbon-12 isotopes at an inlet of the distillation column—can be fed into the inlet of the distillation column and collected from a particular outlet of the distillation column (e.g., an upper outlet proximal a top of the distillation column, a lower outlet proximal a bottom of the distillation column), such that the resulting carbon dioxide mixture, collected at the particular outlet, exhibits a target ratio of carbon-13 isotopes to carbon-12 isotopes. The resulting carbon composition 100—derived from this carbon dioxide mixture exhibiting the target ratio of carbon-13 to carbon-12 isotopes—can define a target set of material properties corresponding to this target ratio.

For example, a first stream of the carbon dioxide mixture—collected from an upper outlet proximal a top of the distillation column—can exhibit a first ratio of carbon-13 isotopes to carbon-12 isotopes within a first target range (e.g., less than −40.0 parts-per-thousand-versus-PDB-standard). Additionally and/or alternatively, in this example, a second stream of the carbon dioxide mixture—collected from a lower outlet proximal a bottom of the distillation column—can exhibit a second ratio of carbon-13 isotopes to carbon-12 isotopes within a second target range (e.g., greater than −10.0 parts-per-thousand-versus-PDB-standard), ratios of carbon-13 isotopes to carbon-12 isotopes within the second target range greater than ratios of carbon-13 isotopes to carbon-12 isotopes within the first target range. In particular, this example, the second stream of the carbon dioxide mixture—defining a concentration of carbon-13 isotopes exceeding 95 percent—can be: collected from the lower outlet; and mixed with a stream of hydrogen in the methanation reactor to form the hydrocarbon mixture. This hydrocarbon mixture can then be further processed according to Blocks of the method S100 to form the carbon composition 100 exhibiting a target set of material properties—such as including a target thermal conductance and/or a target electrical conductance—corresponding to the concentration of carbon-13 isotopes (e.g., exceeding 95 percent) in the second stream of the carbon dioxide mixture. In particular, in this example, a carbon product formed of the carbon composition 100 can exhibit a higher electrical and/or thermal conductance than a standard carbon product formed of carbon sourced from the ground.

### 11. Certification of Carbon Materials

As described above, non-diamond carbon products (or “carbon materials”) formed of carbon derived from carbon dioxide captured from above-ground gases (e.g., a point source, atmospheric air) can similarly be configured to exhibit a carbon isotopic signature distinct from counterpart carbon materials formed of carbon derived from.

In particular, in one implementation, these carbon isotopic signatures can be leveraged to distinguish a carbon composition 100—such as forming graphene, graphite, carbon black, carbon nanotubes, etc.—formed of carbon sourced from above-ground gas from counterpart carbon materials formed of carbon sourced from the ground.

In particular, a carbon isotopic signature—defining carbon isotopic concentrations (e.g., of Carbon-13 and/or Carbon-12)—can be derived for a carbon material (e.g., carbon black, graphene, graphite, carbon nanotubes) via execution of a standard carbon-13 test, such as via implementation of mass spectroscopy techniques, as described above. This standard carbon-13 test can therefore be executed to: derive a carbon isotopic signature for a carbon material (e.g., a solid carbon material)—such as including graphite, graphene, carbon black, carbon nanotubes, diamond, etc.—via mass spectroscopy; predict a source of carbon included in this particular carbon material based on the carbon isotopic signature; and thus selectively certify (e.g., verify, quality check) the carbon material as derived from carbon sourced from above-ground gas—such as including a volume of gas captured via point-source or direct air capture—or from the ground.

In this implementation, Blocks of the method S100 can include: confirming receipt of a carbon product of a product type (e.g., graphite, graphene, carbon black, carbon nanotubes) at a testing facility at a first time in Block S150; accessing a set of isotopic data derived for the carbon product via execution of a carbon test during a test period succeeding the first time in Block S160; deriving a carbon isotopic signature—defining a first concentration of carbon-13 isotopes—for the carbon product based on the set of isotopic data in Block S170; accessing a baseline concentration of carbon-13 isotopes defined for a representative carbon product of the product type including carbon sourced from above-ground gas (e.g., a point source, atmospheric air); characterizing a difference between the first concentration and the baseline concentration in Block S172; in response to the difference falling below a threshold difference, certifying the carbon product as an “gas-captured” carbon product including carbon sourced from above-ground gas in Block S180; and, in response to the difference exceeding the threshold difference, withholding certification of the carbon product as an “gas-captured” carbon product in Block S180. Blocks of the method S100 can further include: generating a report including the first concentration of carbon-13 isotopes and indicating certification of the carbon product as an “gas-captured” carbon product in Block S190; and transmitting the report to a user affiliated with the carbon product in Block S192.

In one example, a “gas-captured” carbon material (i.e., the carbon composition 100)—such as a carbon material including carbon sourced from above ground gas (e.g., a point source, atmospheric air)—can be defined as a carbon material exhibiting a ratio of carbon-13 isotopes to carbon-12 isotopes exceeding −50 parts-per-thousand-versus-PDB-standard. Therefore, a carbon material defining a ratio of carbon-13 isotopes to carbon-12 isotopes—defining the carbon isotopic signature of the carbon material—exceeding −50 parts-per-thousand-versus-PDB-standard can be certified as an “gas-captured” carbon material and therefore distinguished from carbon materials formed of carbon sourced from the ground and defining ratios of carbon-13 isotopes to carbon-12 isotopes less than −50 parts-per-thousand-versus-PDB-standard.

Additionally and/or alternatively, in other examples, an “gas-captured” carbon material can be defined as a carbon material exhibiting a ratio of carbon-13 isotopes to carbon-12 isotopes: exceeding −45 parts-per-thousand-versus-PDB-standard and less than 5 parts-per-thousand-versus-PDB-standard; exceeding −40 parts-per-thousand-versus-PDB-standard and less than 5 parts-per-thousand-versus-PDB-standard; exceeding −35 parts-per-thousand-versus-PDB-standard and less than −15 parts-per-thousand-versus-PDB-standard; etc.

Therefore, each instance of the carbon composition 100—such as the graphene composition 104, the graphite composition 102, the carbon black composition 106, the nanotube composition 108, and/or the diamond composition 110—can be certified as formed of carbon derived from above-ground gas (e.g., a point source, atmospheric air) based on the isotopic signature of the carbon composition 100. However, counterpart carbon materials (e.g., graphene, graphite, carbon black, carbon nanotubes, diamond) formed of carbon derived from the ground can be certified as formed of carbon derived from the ground based on isotopic signatures—differing from isotopic signatures of instances of the carbon composition 100—of these counterpart carbon materials.

As a person skilled in the art will recognize from the previous detailed description and from the figures and claims, modifications and changes can be made to the embodiments of the invention without departing from the scope of this invention as defined in the following claims.

I claim:

1. A solid carbon composition:
forming graphene comprising carbon sourced from captured gas and comprising;
a first amount of carbon-13 isotopes; and
a second amount of carbon-12 isotopes; and
exhibiting an isotopic signature defining a ratio of the first amount of carbon-13 isotopes to the second amount of carbon-12 isotopes exceeding −50.0 parts-per-thousand-versus-PDB-standard.

2. The solid carbon composition of claim 1, comprising graphene:
comprising carbon sourced from captured gas;
formed via microwave deposition of a hydrocarbon mixture comprising methane derived from carbon dioxide extracted from captured gas; and
exhibiting the isotopic signature defining the ratio of the first amount of carbon-13 isotopes to the second amount of carbon-12 isotopes exceeding −45.0 parts-per-thousand-versus-PDB-standard and less than −10 parts-per-thousand-versus-PDB-standard.

3. The solid carbon composition of claim 1, comprising graphene:
comprising carbon sourced from captured gas;
formed via plasma pyrolysis of a hydrocarbon mixture comprising methane derived from carbon dioxide extracted from captured gas; and
exhibiting the isotopic signature defining the ratio of the first amount of carbon-13 isotopes to the second amount of carbon-12 isotopes exceeding −50.0 parts-per-thousand-versus-PDB-standard and less than −15 parts-per-thousand-versus-PDB-standard.

4. The solid carbon composition of claim 1:
comprising carbon sourced from captured gas and excluding carbon sourced from ground;
comprising graphene defining a concentration of carbon-13 within a first concentration range, concentrations of carbon-13 within the first concentration range exceeding an average concentration of carbon-13 exhibited by graphene comprising carbon sourced from ground; and
exhibiting the isotopic signature defining the ratio of the first amount of carbon-13 isotopes to the second amount of carbon-12 isotopes exceeding −40.0 parts-per-thousand-versus-PDB-standard and less than zero parts-per-thousand-versus-PDB-standard.

5. The solid carbon composition of claim 1:
formed via:
heating of a hydrocarbon mixture comprising methane within a graphene reactor and according to a target heating protocol to dissociate carbon from hydrogen within the graphene reactor, the target heating protocol corresponding to graphene; and
cooling carbon collected from the graphene reactor according to a target cooling protocol to form graphene, the target cooling protocol corresponding to graphene; and
wherein the hydrocarbon mixture:
comprises methane comprising carbon sourced from captured gas; and
is formed via methanation of a carbon dioxide mixture extracted from captured gas and comprising carbon dioxide and impurities.

6. The solid carbon composition of claim 1:
comprising graphene derived from a hydrocarbon mixture:
comprising methane comprising carbon sourced from captured gas; and
formed via methanation of a carbon dioxide mixture extracted from captured gas comprising a flue gas via a point source capture process; and
exhibiting the isotopic signature defining the ratio of the first amount of carbon-13 isotopes to the second amount of carbon-12 isotopes exceeding −50.0 parts-per-thousand-versus-PDB-standard and less than −15.0 parts-per-thousand-versus-PDB-standard.

7. The solid carbon composition of claim 1:
comprising graphene derived from a hydrocarbon mixture:
comprising methane comprising carbon sourced from captured gas; and
formed via methanation of a carbon dioxide mixture extracted from captured gas comprising air via a direct air capture process; and
exhibiting the isotopic signature defining the ratio of the first amount of carbon-13 isotopes to the second amount of carbon-12 isotopes exceeding −20.0 parts-per-thousand-versus-PDB-standard and less than zero parts-per-thousand-versus-PDB-standard.

8. A solid carbon composition:
forming graphite comprising carbon sourced from captured gas and comprising;
a first amount of carbon-13 isotopes; and
a second amount of carbon-12 isotopes; and
exhibiting an isotopic signature defining a ratio of the first amount of carbon-13 isotopes to the second amount of carbon-12 isotopes exceeding −50.0 parts-per-thousand-versus-PDB-standard.

9. The solid carbon composition of claim 8, comprising graphite:
comprising carbon sourced from captured gas;
formed via microwave deposition of a hydrocarbon mixture comprising methane derived from carbon dioxide extracted from captured gas; and
exhibiting the isotopic signature defining the ratio of the first amount of carbon-13 isotopes to the second amount of carbon-12 isotopes exceeding −45.0 parts-per-thousand-versus-PDB-standard and less than −10 parts-per-thousand-versus-PDB-standard.

10. The solid carbon composition of claim 8, comprising graphite:
comprising carbon sourced from captured gas;
formed via plasma pyrolysis of a hydrocarbon mixture comprising methane derived from carbon dioxide extracted from captured gas; and
exhibiting the isotopic signature defining the ratio of the first amount of carbon-13 isotopes to the second amount of carbon-12 isotopes exceeding −50.0 parts-per-thousand-versus-PDB-standard and less than −15 parts-per-thousand-versus-PDB-standard.

11. The solid carbon composition of claim 8, comprising graphite:
comprising carbon sourced from captured gas and excluding carbon sourced from ground; and
defining a concentration of carbon-13 within a first concentration range, concentrations of carbon-13 within the first concentration range exceeding an average concentration of carbon-13 exhibited by graphite comprising carbon sourced from ground.

12. The solid carbon composition of claim 8:
formed via:
heating of a hydrocarbon mixture comprising methane within a graphite reactor and according to a target heating protocol to dissociate carbon from hydrogen within the graphite reactor, the target heating protocol corresponding to graphite; and
cooling carbon collected from the graphite reactor according to a target cooling protocol to form graphite, the target cooling protocol corresponding to graphite; and
wherein the gaseous hydrocarbon mixture:
comprises methane comprising carbon sourced from captured gas; and
is formed via methanation of a carbon dioxide mixture extracted from captured gas and comprising carbon dioxide and impurities.

13. The solid carbon composition of claim 8:
comprising graphite derived from a hydrocarbon mixture:
comprising methane comprising carbon sourced from captured gas; and
formed via methanation of a carbon dioxide mixture extracted from captured gas comprising a flue stack via a point source capture process; and
exhibiting the isotopic signature defining the ratio of the first amount of carbon-13 isotopes to the second amount of carbon-12 isotopes exceeding −50.0 parts-per-thousand-versus-PDB-standard and less than −15.0 parts-per-thousand-versus-PDB-standard.

14. The solid carbon composition of claim 8:
comprising graphite derived from a hydrocarbon mixture:
comprising methane comprising carbon sourced from captured gas; and
formed via methanation of a carbon dioxide mixture extracted from captured gas comprising air via a direct air capture process; and
exhibiting the isotopic signature defining the ratio of the first amount of carbon-13 isotopes to the second amount of carbon-12 isotopes exceeding −20.0 parts-per-thousand-versus-PDB-standard and less than zero parts-per-thousand-versus-PDB-standard.

15. A method comprising:
extracting a carbon dioxide mixture from a volume of gas, the carbon dioxide mixture comprising carbon dioxide and defining a first ratio of carbon-13 isotopes to carbon-12 isotopes exceeding −40 parts-per-thousand-versus-PDB-standard and less than zero parts-per-thousand-versus-PDB-standard;
reacting the carbon dioxide mixture with a stream of hydrogen, in the presence of a catalyst, to generate a hydrocarbon mixture comprising methane and defining a second ratio of carbon-13 isotopes to carbon-12 isotopes less than the first ratio; and
in a reactor, converting the hydrocarbon mixture to a target carbon composition via a target conversion process corresponding to the target carbon composition, the target carbon composition comprising carbon and defining a third ratio of carbon-13 isotopes to carbon-12 isotopes less than the second ratio, the third ratio exceeding −50 parts-per-thousand-versus-PDB-standard.

16. The method of claim 15, wherein converting the hydrocarbon mixture to the target carbon composition via the conversion process comprises converting the hydrocarbon mixture to the target carbon composition via a microwave deposition process defining a target cooling rate configured to promote generation of graphene, the target carbon composition comprising graphene comprising carbon and defining the third ratio of carbon-13 isotopes to carbon-12 isotopes exceeding −45 parts-per-thousand-versus-PDB-standard and less than −10 parts-per-thousand-versus-PDB-standard.

17. The method of claim 15, wherein converting the hydrocarbon mixture to the target carbon composition via the conversion process comprises converting the hydrocarbon mixture to the target carbon composition via a plasma pyrolysis process defining a target cooling rate configured to promote generation of graphene, the target carbon composition comprising graphene comprising carbon and defining the third ratio of carbon-13 isotopes to carbon-12 isotopes exceeding −50 parts-per-thousand-versus-PDB-standard and less than −15 parts-per-thousand-versus-PDB-standard.

18. The method of claim 15, wherein converting the hydrocarbon mixture to the target carbon composition via the conversion process comprises converting the hydrocarbon mixture to the target carbon composition via pyrolysis according to a third cooling rate configured to promote generation of graphite, the target carbon composition comprising graphite comprising carbon and defining the third ratio of carbon-13 isotopes to carbon-12 isotopes exceeding −50 parts-per-thousand-versus-PDB-standard and less than −15 parts-per-thousand-versus-PDB-standard.

19. The method of claim 15, wherein converting the hydrocarbon mixture to the target carbon composition via the conversion process comprises converting the hydrocarbon mixture to the target carbon composition via pyrolysis according to a fourth cooling rate configured to promote generation of carbon black, the target carbon composition comprising carbon black comprising carbon and defining the third ratio of carbon-13 isotopes to carbon-12 isotopes exceeding −50 parts-per-thousand-versus-PDB-standard and less than −15 parts-per-thousand-versus-PDB-standard.

20. The method of claim 15:
wherein extracting the carbon dioxide mixture from the volume of gas comprises:
extracting the carbon dioxide mixture from the volume of gas via point-source capture, the carbon dioxide mixture:
comprising carbon dioxide and impurities;
defining a first concentration of carbon dioxide; and
defining the first ratio of carbon-13 isotopes to carbon-12 isotopes exceeding −40 parts-per-thousand-versus-PDB-standard and less than −20 parts-per-thousand-versus-PDB-standard; and
conveying the carbon dioxide mixture through a pressurized unit at temperatures within a first temperature range to promote liquefaction of the carbon dioxide mixture to remove impurities from the carbon dioxide mixture, the carbon dioxide mixture defining a second concentration of carbon dioxide at an outlet of the pressurized unit, the second concentration exceeding the first concentration; and
wherein converting the hydrocarbon mixture to the target carbon composition defining the third ratio of carbon-13 isotopes to carbon-12 isotopes comprises converting the hydrocarbon mixture to the target carbon composition defining the third ratio of carbon-13 isotopes to carbon-12 isotopes exceeding −50 parts-per-thousand-versus-PDB-standard and less than −25 parts-per-thousand-versus-PDB-standard.
